(19) United States
(12) Patent Application Publication
(10) Pub. No.: US 2026/0118792 A1
(43) Pub. Date: Apr. 30, 2026

(54) TONER

(71) Applicant: CANON KABUSHIKI KAISHA, Tokyo (JP)

(72) Inventors: KENJI OOKUBO, Shizuoka (JP); MASAYA KOMURO, Shizuoka (JP)

(21) Appl. No.: 19/355,086

(22) Filed: Oct. 10, 2025

(30) Foreign Application Priority Data
Oct. 28, 2024 (JP) 2024-189017

(51) Int. Cl. G03G 9/093; G03G 9/09

(52) U.S. Cl. CPC G03G 9/09342; G03G 9/091

(57) ABSTRACT

A toner comprising: a toner particle; and a fine particle that is present on a surface of the toner particle, wherein the toner particle comprises an aluminum element on the surface of the toner particle, and the fine particle comprises aluminum hydroxide on a surface the fine particle.

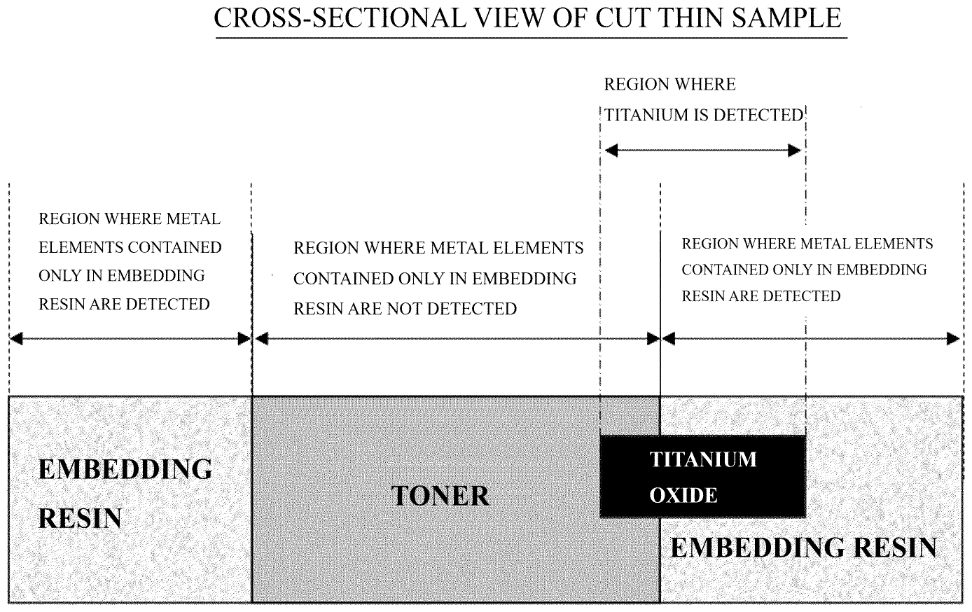

### BACKGROUND

### Field of the Technology

The present disclosure relates to a toner used in an electrophotographic image forming apparatus.

### Description of the Related Art

In an electrophotographic image forming apparatus, higher speed, smaller size, and longer life are required. For this reason, further improvements in various performances for a toner are required to achieve such requirements.

In particular, toner charging is required to be quickly started in order to realize a higher speed. In a case where a toner charge buildup capability is not sufficient, so-called fogging in which a toner with a small amount of charge is also developed in a white base region is likely to occur. This is liable to be an adverse effect in a system that is required to develop a large amount of toner at a high speed, and significantly appears when printing is performed for the first time in the morning, in particular. This is considered to be because the amount of charge of the toner is reset due to an increase in unused time.

For example, Japanese Patent Application Laid-Open No. 2023-128532 discloses a technology enhancing a toner charge buildup capability by an inorganic external additive obtained by covering a surface of an oxide of a metal element with a hydroxide of a metal element.

### SUMMARY

On the other hand, if the toner charge buildup capability is improved, a part of the toner is liable to be overcharged. The overcharged toner exhibits excessively high electrostatic adhesion to members and is likely to lead to member contamination, which is problematic in an increase in lifetime.

The present disclosure provides a toner that can achieve both an improvement in charge buildup capability and an increase in lifetime achieved by reducing member contamination.

The present disclosure relates to a toner comprising: a toner particle; and a fine particle that is present on a surface of the toner particle, wherein the toner particle comprises an aluminum element on the surface of the toner particle, and the fine particle comprises aluminum hydroxide on a surface the fine particle.

Features of the present disclosure will become apparent from the following description of embodiments with reference to the attached drawings. The following description of embodiments are described by way of example.

### BRIEF DESCRIPTION OF THE DRAWINGS

The FIGURE is an overview diagram of a cut thin piece sample section.

### DESCRIPTION OF THE EMBODIMENTS

In the present disclosure, the description “from XX to YY” or “XX to YY” representing a numerical range means a numerical range including a lower limit and an upper limit, which are endpoints, unless otherwise specified. Also, when numerical ranges are described in a stepwise manner, the upper and lower limits of each of the numerical ranges can be arbitrarily combined. In addition, in the present disclosure, the description such as “at least one selected from the group consisting of XX, YY and ZZ” means any of XX, YY, and ZZ, a combination of XX and YY, a combination of XX and ZZ, a combination of YY and ZZ, or a combination of XX, YY, and ZZ. In the case where XX represents a group, a plurality of members may be selected from XX, and the same is true for YY and ZZ.

The present disclosure relates to a toner including: a toner particle; and a fine particle that is present on a surface of the toner particle, the toner particle containing an aluminum element on the surface, and the fine particle containing aluminum hydroxide on a surface.

The present inventors have discovered that it is possible to achieve both an improvement in charge buildup capability and an increase in lifetime achieved by reducing member contamination with the above-described configuration. The present inventors have presumed the reason therefor as follows.

The toner to which the fine particle having aluminum hydroxide on a surface thereof have been externally added exhibits a satisfactory charge buildup capability due to a quick charge buildup capability of aluminum hydroxide in the process of the toner being charged by rubbing. On the other hand, it is considered that there are regions that have been rubbed and regions that have not been rubbed on the toner surface of a single particle, which is thought to cause non-uniformity of the amount of charging to occur. In particular, a local amount of charge tends to increase in a toner having a high charge buildup capability. In a case where the local amount of charge is excessively large, an electrostatic adhesion to members increases in a region on the toner surface where the amount of charge is large, which results in member contamination. For example, a toner that is not developed may follow a photosensitive member by adhering to the photosensitive member and may melt-adhere to the photosensitive member by repeating contact with each member. This may cause an adverse effect such as occurrence of image streaks.

On the other hand, in a case where an aluminum element is present on the surface of the toner particle like in the toner of the present disclosure, the charge imparted to the aluminum hydroxide is made uniform over the entire surface of the toner via the surface of the toner particle, and localization of the charge on the toner surface is alleviated. This effect may occur in the combination of the fine particle having aluminum hydroxide on its surface and the toner particle having an aluminum element on its surface. The present inventors expect that this is because a strong bond like chelate coordination occurs between an Al—OH structure of aluminum hydroxide and the Al element. It is estimated that such a mechanism can achieve both an improvement in charge buildup capability and an increase in lifetime achieved by reducing member contamination.

Hereinafter, preferred modes related to the toner will be described. Note that the present disclosure is not limited to the preferred modes.

It is only necessary for the fine particle to contain aluminum hydroxide on its surface, and the fine particle is not particularly limited. The fine particle has, for example, a substrate and aluminum hydroxide on a surface of the substrate. The substrate of the fine particle is preferably an inorganic material. The fine particle may be obtained by covering the surface of the substrate with aluminum hydroxide. The entire surface of the fine particle may not necessarily be covered with aluminum hydroxide, and a part of the substrate may be exposed. For example, a part or an entirety of the substrate of the fine particle is covered with aluminum hydroxide.

The substrate of the fine particle is an inorganic oxide fine particle constituted of a silica fine particle, an alumina-coated silica fine particle (silica-alumina), an alumina fine particle, or a titanium oxide fine particle, an inorganic titanic acid compound fine particle such as strontium titanate, or zinc titanate, or the like. The substrate is preferably an inorganic oxide fine particle. In other words, the fine particle preferably have an inorganic oxide fine particle and aluminum hydroxide on a surface of the inorganic oxide fine particle. The substrate preferably contains at least one selected from the group consisting of a silica fine particle and an alumina-coated silica fine particle.

More preferably, the substrate contains a silica fine particle in terms of a charging performance imparting property. In other words, it is more preferable that the fine particles have a silica fine particle and aluminum hydroxide on the surface of the silica fine particle. For example, the fine particle is preferably a silica fine particle with a surface covered with aluminum hydroxide. As the silica fine particle, both a dry silica fine particle which is so-called dry method or fumed silica and is produced by vapor phase oxidation of silicon halides and a so-called wet method silica fine particle manufactured from water glass or the like can be used.

The fine particle needs to have aluminum hydroxide on its surface. The presence of aluminum hydroxide on the surface enables a charge buildup capability to be expressed. The fine particle preferably has a substrate and aluminum hydroxide on the surface of the substrate. The substrate enables aluminum hydroxide to be present in a thin thickness on the surface of the fine particle, and it is possible to expect a charging performance control effect that the fine particle substrate has without inhibiting the charging performance of the fine particle substrate.

Whether the fine particle has aluminum hydroxide on its surface can be confirmed by energy-dispersive X-ray spectroscopy mapping (TEM-EDS mapping) and X-ray diffraction patterns (XRD) of a transmission electron microscope. The TEM-EDS mapping can confirm a presence state of the aluminum element with a thickness of several nm that is present on the surface of the substrate of the fine particle. Also, it is possible to qualitatively determine whether aluminum contained in the fine particle is an oxide or hydroxide in the XRD.

If aluminum is present as aluminum oxide, a clear peak depending on the crystal system appears. On the other hand, in a case where aluminum is present as aluminum hydroxide, no clear peaks are detected in the XRD patterns. Methods of measuring the TEM-EDS mapping and the XRD will be described below.

The toner has a toner particle and a fine particle that is present on the surface of the toner particle. The toner has the fine particle, for example, as an external additive. For the external addition of the fine particle to the surface of the toner particle, it is possible to use a known method. Examples thereof include fixation using a Henschel mixer (dry method) and a method for achieving fixation by dispersing the toner particle and the fine particle in a solvent and then aggregating them (wet method).

The coverage ratio of the aluminum element included in aluminum hydroxide with respect to the substrate, which is calculated from a mapping image of the aluminum hydroxide and an element of the substrate obtained by element mapping analysis (STEM-EDS mapping or STEM-EELS mapping) using STEM on the fine particle, is 40% to 110%, and is preferably 40% to 90% or less, for example.

The fine particle substrate is sufficiently covered with aluminum hydroxide by the coverage ratio of the aluminum element included in aluminum hydroxide with respect to the fine particle substrate (hereinafter, also referred to as an aluminum hydroxide coverage ratio”) being 40% or more. This facilitates a further improvement in charge buildup capability and charging stability. On the other hand, the charging property that the substrate has is not inhibited and a more satisfactory charging property is exhibited by the aluminum hydroxide coverage ratio being 90% or less, which is preferable.

The aluminum hydroxide coverage ratio is calculated by S4/S3×100, where the number of pixels occupied by the substrate element in the mapping image is defined as S3 and the number of pixels occupied by aluminum is defined as S4. A specific calculation method of the coverage ratio will be described later. The aluminum hydroxide coverage ratio of the fine particle is more preferably 70% to 90%, and is further preferably 75% to 90%.

As a method for covering the fine particle substrate with aluminum hydroxide, the following method can be listed, for example. A water-soluble salt of aluminum is prepared first, an aqueous solution of the water-soluble salt is added to the fine particle substrate, and an alkaline substance such as an aqueous solution of sodium hydroxide is then added thereto, thereby causing hydrolysis of the water-soluble salt of aluminum. It is possible to cover the fine particle substrate with aluminum hydroxide by this method.

Examples of such a water-soluble salt of aluminum include chloride, bromide, sulfate, nitrate, acetate, carbonate, and hydrogen carbonate of aluminum.

Aluminum hydroxide can be selectively formed on the surface of the fine particle substrate by controlling conditions (such as pH and temperature at the time of warming) when the fine particle substrate is covered. For example, the coverage ratio of aluminum hydroxide with respect to the substrate can be increased by setting pH to 5.0 to 6.0 and the temperature to 70° C. to 95° C.

Also, the surface of the fine particle may be made hydrophobic through a surface treatment from the viewpoint of curbing variations in charging performance in a high-temperature and high-humidity environment and a low-temperature and low-humidity environment. Examples of the surface treatment can include silane compound treatment such as silane coupling treatment, and oil treatment, and such a surface treatment can be appropriately selected. It is also possible to select multiple types of surface treatments, and the order of such treatments is also arbitrary. For example, it is possible to cover the surface of the fine particle substrate with aluminum hydroxide and then subject it to the surface treatment.

Examples of silane coupling agents may include hexamethyldisilazane, trimethylsilane, n-propyltrimethoxysilane, n-butyltrimethoxysilane, isobutyltrimethoxysilane, octyltriethoxysilane, decyltriethoxysilane, dodecyltriethoxysilane, trimethylchlorosilane, trimethylethoxysilane, dimethyldichlorosilane, methyltrichlorosilane, allyldimethylchlorosilane, allylphenyldichlorosilane, benzyldimethylchlorosilane, bromomethyldimethylchlorosilane, α-chloroethyltrichlorosilane, β-chloroethyltrichlorosilane, chloromethyldimethylchlorosilane, triorganosilyl mercaptan, trimethylsilyl mercaptan, triorganosilyl acrylate, vinyldimethylacetoxysilane, dimethylethoxysilane, dimethyldimethoxysilane, diphenyldiethoxysilane, 1-hexamethyldisiloxane, 1,3-divinyltetramethyldisiloxane, 1,3-diphenyltetramethyldisiloxane, and dimethylpolysiloxanes having 2 to 12 siloxane units per molecule, each terminally located siloxane unit containing one hydroxyl group attached to Si. These may be used alone, or two or more kinds may be used in combination.

Preferred silane compounds include alkyltrialkoxysilanes having an alkyl group having 1 to 8 carbon atoms and an alkoxy group having 1 to 3 carbon atoms. Among these alkyltrialkoxysilanes, at least one selected from the group consisting of n-propyltrimethoxysilane, n-butyltrimethoxysilane, and isobutyltrimethoxysilane is preferable. Among these, isobutyltrimethoxysilane is more preferable from the viewpoint of curbing variations in charging performance. Also, the fine particle may be treated with a silicone oil or with a silicone oil and a silane compound in combination.

Preferably, the fine particle is surface-treated with an alkyltrialkoxysilane (having an alkyl group having 1 to 8 carbon atoms and an alkoxy group having 1 to 3 carbon atoms, for example). More preferably, aluminum hydroxide that is present on the surface of the fine particle is surface-treated with an alkyltrialkoxysilane (having an alkyl group having 1 to 8 carbon atoms and an alkoxy group having 1 to 3 carbon atoms, for example). The charging property is less likely to be changed due to humidity by the fine particle being surface-treated. The alkyltrialkoxysilane is more preferably isobutyltrimethoxysilane.

The number-average particle diameter of the primary particle of the fine particle is preferably 10 nm to 50 nm. A good disintegrating property is achieved and the fine particle is externally added to the toner surface in a uniformly dispersed state by the number-average particle diameter being 10 nm or more, and the charge buildup capability in a high-temperature and high-humidity environment is further maintained by embedding in the toner base particle surface being curbed even in long-term use. In contrast, the toner particle can be heated and melted without obstructing the heat flow from a fixing heater and low-temperature fixability is maintained by the number-average particle diameter being 50 nm or less. The number-average particle diameter of the primary particle of the fine particle is more preferably 10 nm to 30 nm, and is further preferably 12 nm to 25 nm.

The content of the fine particle with respect to the toner is preferably 0.10% by mass to 5.00% by mass, and is more preferably 0.20% by mass to 2.00% by mass. The content of the fine particle is preferably 0.10 parts by mass to 5.00 parts by mass, is more preferably 0.20 parts by mass to 3.00 parts by mass, and is still more preferably 0.20 parts by mass to 2.00 parts by mass with respect to 100 parts by mass of toner particle.

The toner particle includes an aluminum element on its surface. The toner particle may be, for example, a resin particle having an aluminum element on its surface. It is preferable that the aluminum element be held on the surface of the toner particle via an ionic bond. Examples of the toner with an aluminum element ion-bonded to the surface of the toner particle include an emulsion aggregated toner using an aggregation agent containing an aluminum element. The toner particle is preferably an emulsion aggregated toner particle.

The amount of aluminum that is present on the toner particle surface can be obtained by time-of-flight secondary ion mass spectrometry (TOF-SIMS). The amount C_{Al} of aluminum element that is present on the toner particle surface which is obtained by TOF-SIMS is 0.0008 atomic % to 2.0 atomic %, is preferably 0.001 atomic % to 2.0 atomic %, is more preferably 0.001 atomic % to 1.0 atomic %, and is further preferably 0.05 atomic % to 1.0 atomic %, for example. A method for measuring C_{Al} will be described later.

C_{Al} can be easily increased by, for example, increasing the number of parts of an aggregating agent containing an aluminum element. Also, C_{Al} can be easily reduced by strengthening a washing process after the aggregation, for example.

The toner particle may be a resin particle. The toner particle contains, for example, a binder resin. For example, homopolymers of aromatic vinyl compounds and substituted products thereof, such as polystyrene and polyvinyltoluene; copolymers of aromatic vinyl compounds, such as styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-dimethylaminoethyl acrylate copolymers, styrene-methyl methacrylate copolymers, styrene-ethyl methacrylate copolymers, styrene-butyl methacrylate copolymers, styrene-dimethylaminoethyl methacrylate copolymers, styrene-vinyl methyl ether copolymers, styrene-vinyl ethyl ether copolymers, styrene-vinyl methyl ketone copolymers, styrene-butadiene copolymers, styrene-isoprene copolymers, styrene-maleic acid copolymers and styrene-maleic acid ester copolymers; homopolymers of aliphatic vinyl compounds and substituted products thereof, such as polyethylene and polypropylene; vinyl resins such as poly(vinyl acetate), poly(vinyl propionate), poly(vinyl benzoate), poly(vinyl butyrate), poly(vinyl formate) and poly(vinyl butyral); vinyl ether-based resins; vinyl ketone-based resins; acrylic polymers, methacrylic polymers; silicone resins; polyester resins; polyamide resins; epoxy resins; phenolic resins; rosins, modified rosins, terpene resins, and so on, can be used as materials of the binder resin contained in the toner particle. It is possible to use one of these polymerizable monomers in isolation or a combination of a plurality of types thereof.

Examples of polymerizable monomers that form copolymers of aromatic vinyl compounds include those listed below. That is, styrene and styrene derivatives such as α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene and p-phenylstyrene.

Examples of polymerizable monomers that form acrylic polymers include acrylic polymerizable monomers such as acrylic acid, methyl acrylate, ethyl acrylate, n-propyl acrylate, iso-propyl acrylate, n-butyl acrylate, iso-butyl acrylate, tert-butyl acrylate, n-amyl acrylate, n-hexyl acrylate, 2-ethylhexyl acrylate, n-octyl acrylate, n-nonyl acrylate, cyclohexyl acrylate, benzyl acrylate, dimethyl phosphate ethyl acrylate, diethyl phosphate ethyl acrylate, dibutyl phosphate ethyl acrylate and 2-benzoyloxyethyl acrylate.

Examples of polymerizable monomers that form methacrylic polymers include methacrylic polymerizable monomers such as meth acrylic acid, methyl methacrylate, ethyl methacrylate, n-propyl methacrylate, iso-propyl methacrylate, n-butyl methacrylate, iso-butyl methacrylate, tert-butyl methacrylate, n-amyl methacrylate, n-hexyl methacrylate, 2-ethylhexyl methacrylate, n-octyl methacrylate, n-nonyl methacrylate, diethyl phosphate ethyl methacrylate and dibutyl phosphate ethyl methacrylate.

As the polyester resin, a polyester resin obtained by condensation polymerization of a carboxylic acid component and an alcohol component, which will be listed below, can be used.

The carboxylic acid component can be at least one selected from the group consisting of terephthalic acid, isophthalic acid, phthalic acid, fumaric acid, maleic acid, dodecenylsuccinic acid, cyclohexanedicarboxylic acid, and trimellitic acid.

The alcohol component can be at least one selected from the group consisting of bisphenol A, hydrogenated bisphenol, an ethylene oxide (1 to 5 moles, for example) adduct of bisphenol A, a propylene oxide (1 to 5 moles, for example) adduct of bisphenol A, glycerin, trimethylol propane, and pentaerythritol.

The polyester resin may be a polyester resin containing a urea group. The polyester resin preferably has a carboxyl group uncapped at the terminal and the like.

The glass transition temperature of the binder resin is, for example, 50° C. to 120° C. or 55° C. to 90° C.

The number-average molecular weight Mₙ of the binder resin is preferably 2000 to 20000 or 3000 to 10000. The value M_{w}/Mₙ of the ratio of the weight-average molecular weight M_{w} to the number-average molecular weight Mₙ of the binder resin is preferably 2.0 to 10.0 or 4.0 to 7.0.

The acid value of the binder resin is preferably 1 mgKOH/g to 30 mgKOH/g or 2 mgKOH/g to 10 mgKOH/g. Also, the hydroxyl value of the binder resin is preferably 1 mgKOH/g to 30 mgKOH/g or 10 mgKOH/g to 30 mgKOH/g.

The binder resin may have a polymerizable functional group for the purpose of improving a change in viscosity of the toner at a high temperature. Examples of the polymerizable functional group include a vinyl group, an isocyanate group, an epoxy group, an amino group, a carboxyl group, and a hydroxy group.

Among these, styrene-based copolymers, which are particularly represented by styrene-butyl acrylate, and polyester resins are preferable in terms of developing properties, fixability, and the like. Note that a method for manufacturing the polymers is not particularly limited, and a known method can be used. The binder resin preferably contains a polyester resin, and more preferably contains an amorphous polyester resin.

Next, external additives will be described. The toner includes a fine particle containing aluminum hydroxide on its surface. The toner may include external additives other than the fine particle in addition to the fine particles. With other external additives, it is possible to control fluidity, charging performance, and a cleaning property, for example.

Examples of other external additives include inorganic oxide fine particles such as a silica fine particle, an alumina fine particle, and a titanium oxide fine particle, inorganic stearic acid compound fine particles such as an aluminum stearate fine particle and a zinc stearate fine particle, and inorganic titanate compound fine particles such as strontium titanate and zinc titanate. These external additives may be used alone, or two or more kinds may be used in combination. Also, these particles may be surface-treated with a silane coupling agent, a titanium coupling agent, a silicone oil, and the like.

Other external additives preferably include a silica fine particle. The silica fine particle is preferably spherical silica. Spherical silica is less likely to be embedded in the toner particle, and it is thus easy to maintain fluidity through durable use. Specifically, spherical silica that contains silicon and has an average value of its shape factor SF-1 of from 105 to 120 and an average value of SF-2 of from 100 to 130 is preferable.

Spherical silica is not particularly limited as long as the above conditions are satisfied, and examples thereof include a sol-gel silica particle, a fused silica particle, an organic silicon polymer particle, and combinations thereof. Furthermore, these particles may be surface-treated with a silane coupling agent, a titanium coupling agent, a silicone oil, or the like.

The total amount of added external additives including the fine particle containing aluminum hydroxide on its surface is preferably from 0.05 parts by mass to 10.00 parts by mass, is more preferably from 0.1 parts by mass to 5.0 parts by mass in total with respect to 100 parts by mass of toner particle.

A known method can be used to fix the external additives to toner particle surface. Examples thereof include fixation using a Henschel mixer (dry method) and a method for achieving fixation by dispersing the toner particle and the external additives in a solvent and then aggregating them (wet method).

The toner preferably has a region where an inorganic fine particle is embedded on the surface of the toner particle. Among these, the inorganic fine particle is preferably a titanium oxide fine particle. It is possible to further maintain the charge buildup capability achieved by aluminum hydroxide even in long-term use, by using the toner particle with a titanium oxide fine particle embedded in its surface as an external additive and the fine particle having aluminum hydroxide on its surface in combination. Furthermore, the inorganic fine particle is more preferably a needle-like titanium oxide fine particle. The form in which the needle-like titanium oxide fine particle is embedded can effectively curb the burying of the titanium oxide fine particle in the toner particle even in long-term use, and not only can further maintain the charge buildup capability but also can further effectively curb a decrease in fluidity.

Examples of the method for embedding the titanium oxide fine particle include a method of increasing the fixing strength in a cyclic method and a method of fusing the titanium oxide fine particle to the toner surface layer by heating it in a wet method.

The number-average value of a major diameter of the primary particle of the needle-like titanium oxide fine particle is preferably 10 nm to 50 nm, and is more preferably 15 nm to 40 nm. The number-average value of the minor diameter of the primary particle of the needle-like titanium oxide fine particle is preferably 1 nm to 15 nm, and is more preferably 2 nm to 10 nm.

The powder specific resistance value RB of the titanium oxide fine particle is preferably 5.0×10 Ωm to 1.0×10⁸ Ωm or 1.0×10³ Ωm to 1.0×10⁷ Ωm.

Next, a coloring agent will be described.

The toner particle may include a coloring agent as needed. The coloring agent is not particularly limited, and known coloring agents shown below, for example, can be used.

Examples of yellow pigments include yellow iron oxide, Naples Yellow, Naphthol Yellow S, Hansa Yellow G, Hansa Yellow 10G, Benzidine Yellow G, Benzidine Yellow GR, Quinoline Yellow Lake, condensed azo compounds such as Permanent Yellow NCG and Tartrazine Lake, isoindolinone compounds, anthraquinone compounds, azo metal complexes, methine compounds and allylamide compounds. Specific examples thereof include those listed below.

C.I. Pigment Yellow 12, 13, 14, 15, 17, 62, 74, 83, 93, 94, 95, 109, 110, 111, 128, 129, 147, 155, 168 and 180.

Examples of orange pigments include those listed below. Permanent Orange GTR, Pyrazolone Orange, Vulcan Orange, Benzidine Orange G, Indanthrene Brilliant Orange RK and Indanthrene Brilliant Orange GK.

Examples of red pigments include red iron oxide, Permanent Red 4R, Lithol Red, Pyrazolone Red, Watchung Red calcium salt, Lake Red C, Lake Red D, Brilliant Carmine 6B, Brilliant Carmine 3B, condensed azo compounds such as Eosine Lake pigments, Rhodamine Lake B and Alizarin Lake pigments, diketopyrrolopyrrole compounds, anthraquinone compounds, quinacridone compounds, basic dye lake compounds, naphthol compounds, benzimidazolone compounds, thioindigo compounds and perylene compounds. Specific examples thereof include those listed below.
C.I. Pigment Red 2, 3, 5, 6, 7, 23, 48:2, 48:3, 48:4, 57:1, 81:1, 122, 144, 146, 166, 169, 177, 184, 185, 202, 206, 220, 221 and 254.

Examples of blue pigments include Alkaline Blue Lake, Victoria Blue Lake, copper phthalocyanine compounds and derivatives thereof, such as Phthalocyanine Blue, metal-free Phthalocyanine Blue, partially chlorinated products of Phthalocyanine Blue, Fast Sky Blue and Indanthrene Blue BG, anthraquinone compounds and basic dye lake compounds. Specific examples thereof include those listed below. C.I. Pigment Blue 1, 7, 15, 15:1, 15:2, 15:3, 15:4, 60, 62 and 66.

Examples of violet pigments include Fast Violet B and Methyl Violet Lake. Examples of green pigments include Pigment Green B, Malachite Green Lake and Final Yellow Green G. Examples of white pigments include hydrozincite, titanium oxide, antimony white and zinc sulfide.

Examples of black pigments include carbon black, aniline black, non-magnetic ferrite, magnetite, and pigments that are colored black through use of yellow colorants, red colorants and blue colorants listed above. It is possible to use one of these colorants in isolation or a mixture of these, and these can be used in the form of solid solutions.

The coloring agent may be surface-treated with a substance with no polymerization inhibition as needed. The content of the colorant is preferably from 1.0 parts by mass to 15.0 parts by mass relative to 100.0 parts by mass of the binder resin or the polymerizable monomer.

Among these, the toner particle preferably contains C.I. Pigment yellow 74. The molecular structure represented by Formula (Y) below that Pigment Yellow 74 has includes coordination as shown by Formula (Y2) below with the aluminum element that is present on the surface of the toner particle. A strong bond like chelate coordination occurs between the Al—OH structure and the Al element in the fine particle having aluminum hydroxide on its surface, which leads to a strong bond between the fine particle and the toner particle. This is considered to result in promoting a charge imparted to the fine particle to be made uniform on the entire toner surface via the toner surface.

Since Pigment Yellow 74 has a relatively small molecular weight, the pigment yellow 74 is likely to move to a stable position when spherical formation and heat treatment such as annealing treatment of the toner are performed, and the coordination as shown by Formula (Y2) is likely to be obtained.

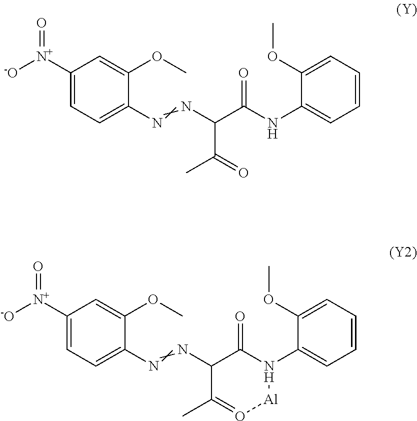

Next, a release agent will be described. The toner particle may contain a release agent. The release agent is not particularly limited, and a known release agent can be used.

Specific examples thereof include petroleum-based wax represented by paraffin wax, microcrystalline wax, or petrolatum and derivatives thereof, montan wax and derivatives thereof, hydrocarbon wax obtained by a Fischer-Tropsch method and derivatives thereof, polyolefin wax represented by polyethylene and derivatives thereof, and natural wax represented by carnauba wax or candelilla wax and derivatives thereof, and the derivatives also include oxides, block copolymers with a vinyl monomer, and graft modified products.

In addition, the examples include alcohols such as higher aliphatic alcohols; fatty acids such as stearic acid and palmitic acid, or acid amides and ketones thereof, hydrogenated castor oils and derivatives thereof, plant waxes, and animal waxes. These waxes may be used alone or in combination.

In the case of using, among these waxes, the polyolefin, the hydrocarbon wax obtained by the Fischer-Tropsch method, or the petroleum-based wax, the developing performance and the transferability tend to be improved, which is preferred. To this wax, an antioxidant may be added to an extent that the effect of the toner is not affected. In addition, the content of the release agent is preferably from 1.0 part by mass to 30.0 parts by mass with respect to 100.0 parts by mass of the binder resin.

The melting point of the release agent is preferably from 30° C. to 120° C., more preferably from 60° C. to 100° C. By using a release agent exhibiting the above-described thermal characteristics, the releasing effect is efficiently developed, and a wider fixing region is secured.

Next, a plasticizer will be described.

The toner particle may contain a crystalline plasticizer in order to improve a sharp melting property. The plasticizer is not particularly limited, and any known plasticizer used in toner as below can be used.

Specifically, esters of a monovalent alcohol and an aliphatic carboxylic acid such as behenyl behenate, stearyl stearate, and pulmiyl palmitate, or esters of a monovalent carboxylic acid and an aliphatic alcohol; Esters of a divalent alcohol and an aliphatic carboxylic acid such as ethylene glycol distearate, dibehenyl sebacate, hexandiol dibehenate, or esters of a divalent carboxylic acid and an aliphatic alcohol; Esters of a trivalent alcohol and an aliphatic carboxylic acid, such as glycerin tribehenate, or esters of a trivalent carboxylic acid and an aliphatic alcohol; Esters of a tetravalent alcohol and an aliphatic carboxylic acid, such as pentaerythritol tetrastearate, pentaerythritol tetrapalmitate, or esters of a tetravalent carboxylic acid and an aliphatic alcohol; Esters of a hexaalcohol and an aliphatic carboxylic acid, such as dipentaerythritol hexastearate, dipentaerythritol hexapalmitate, or esters of a hexacarboxylic acid and an aliphatic alcohol; Esters of polyhydric alcohols and aliphatic carboxylic acids, such as polyglycerin behenate, or esters of polyhydric carboxylic acids and aliphatic alcohols; Natural ester waxes such as carnauba wax and rice wax. These may be used individually or in combination.

The toner particle preferably contains a crystalline polyester. The crystalline polyester is preferably a condensation-polymerized polymer of monomers containing an aliphatic diol and/or an aliphatic dicarboxylic acid. It should be noted that crystalline polyester refers to polyester having a clear melting point as measured using a differential scanning calorimeter (DSC).

The crystalline polyester preferably contains a monomer unit corresponding to aliphatic diol having 2 to 12 (more preferably 6 to 10) carbon atoms and/or a monomer unit corresponding to an aliphatic dicarboxylic acid having 2 to 12 (more preferably 6 to 10) carbon atoms. The crystalline polyester having such a structure provides satisfactory low-temperature fixability of the toner.

Examples of aliphatic diols having from 2 to 12 carbon atoms may include the following compounds: 1,2-ethandiol, 1,3-propanediol, 1,4-butanediol, 1,5-pentanediol, 1,6-hexanediol, 1,7-heptandiol, 1,8-octandiol, 1,9-nonandiol, 1,10-decanediol, 1,11-undecanediol, and 1,12-dodecanediol. Aliphatic diol having a double bond may also be used. Examples of aliphatic diols having a double bond may include the following compounds: 2-butene-1,4-diol, 3-hexene-1,6-diol, and 4-octene-1,8-diol.

Examples of the aliphatic dicarboxylic acids having from 2 to 12 carbon atoms include the following compounds. Oxalic acid, malonic acid, succinic acid, glutaric acid, adipic acid, pimelinic acid, suberic acid, azelaic acid, sebacic acid, 1,9-nonanedicarboxylic acid, 1,10-decanedicarboxylic acid, 1,11-undecanedicarboxylic acid, and 1,12-dodecanedicarboxylic acid. Lower alkyl esters and acid anhydrides of these aliphatic dicarboxylic acids may also be used. Among them, sebacic acid, adipic acid and 1,10-decanedicarboxylic acid, and lower alkyl esters and acid anhydrides thereof are preferred. These can be used individually or in combination of two or more types thereof.

Also, aromatic carboxylic acid can also be used. As examples of the aromatic dicarboxylic acid, there are the following compounds. Terephthalic acid, isophthalic acid, 2,6-naphthalenedicarboxylic acid and 4,4-diphenyldicarboxylic acid. Among these, terephthalic acid is preferable from a viewpoint that it is readily available and can easily form a polymer having a low melting point.

A dicarboxylic acid having a double bond may also be used. A dicarboxylic acid having a double bond may be suitably used to suppress hot offset during fixation in that the double bond can be utilized to cross-link the entire resin. Examples of such dicarboxylic acids may include fumaric acid, maleic acid, 3-hexenedioic acid, and 3-octenedioic acid. Examples thereof may also include these lower alkyl esters and acid anhydrides thereof. Among them, fumaric acid and maleic acid are more preferable.

A method for producing a crystalline polyester is not particularly limited, and it can be produced by a general polyester polymerization method in which a dicarboxylic acid component and a diol component are reacted. For example, it can be manufactured using a direct polycondensation method or an ester exchange method depending on the type of monomer.

The content of crystalline polyester in the toner particle is preferably from 3.0% by mass to 15.0% by mass from the viewpoint of a balance between low-temperature fixability and durability. The melting point of crystalline polyester is, for example, 50° C. to 120° C. or 60° C. to 90° C.

The number-average molecular weight Mₙ of the crystalline polyester is preferably 5000 to 30000 or 6000 to 20000. Also, the value Mw/Mn of the ratio of the weight-average molecular weight Mw with respect to the number-average molecular weight Mn of the crystalline polyester is preferably 1.0 to 10.0 or 1.0 to 4.0. The acid value of the crystalline polyester is preferably 1 mgKOH/g to 20 mgKOH/g or 2 mgKOH/g to 10 mgKOH/g.

Next, a charge control agent will be described. The toner particle may contain a charge control agent. As the charge control agent, known charge control agents can be used, and in particular, a charge control agent that is high in triboelectric charging speed and capable of stably maintaining a constant triboelectric charge quantity is preferred. Furthermore, in the case of producing a toner particle by a suspension polymerization method, a charge control agent is particularly preferred, which is low in polymerization inhibition performance and substantially free of solubilized products in the aqueous medium.

Examples of agents that control the toner to be negatively charged include monoazo metal compounds, acetylacetone metal compounds, aromatic oxycarboxylic acid, aromatic dicarboxylic acid, and oxycarboxylic and dicarboxylic acid-based metal compounds, aromatic oxycarboxylic acids, aromatic mono- and poly-carboxylic acids, and metal salts, anhydrides, and esters thereof, phenol derivatives such as bisphenol, urea derivatives, metal-containing salicylic acid-based compounds, metal-containing naphthoic acid-based compounds, boron compounds, quaternary ammonium salts, calixarenes, and charge control resins.

On the other hand, examples of a substance that controls the toner to have positive chargeability include the following substances. In other words, examples thereof include nigrosine and nigrosine-modified products such as a fatty acid metal salt, a guanidine compound, an imodazole compound, quaternary ammonium salts such as tributylbenzyl ammonium-1-hydroxy-4-naphthosulfonate and tetrabutylammonium tetrafluoroborate, and onium salts such as phosphonium salts that are analogues thereof and lake pigments thereof, triphenylmethane dyes and lake pigments thereof (examples of laking agents include phosphotungstic acid, phosphomolybdic acid, phosphotungstomolybdic acid, tannic acid, lauric acid, gallic acid, ferricyanic acid, ferrocyanide compounds, and the like), metal salts of higher fatty acids, and resin-based charge control agents.

Examples of the charge control resin can include polymers or copolymers having a sulfonic acid group, a sulfonic acid base, or a sulfonic acid ester group. The polymer having a sulfonic acid group, a sulfonic acid base, or a sulfonic acid ester group is preferably, in particular, a polymer containing a sulfonic acid group-containing acrylamide-base monomer or a sulfonic acid group-containing methacrylamide-based monomer in a copolymerization ratio of 2% by mass or more, more preferably 5% by mass or more.

These charge control agents or charge control resins may be added alone or, two or more thereof may be added in combination. The amount of the charge control agent or charge control resin added is preferably from 0.01 parts by mass to 20.0 parts by mass, more preferably from 0.5 parts by mass to 10.0 parts by mass or with respect to 100.0 parts of the binder resin.

Next, a method for manufacturing the toner particle will be described. Although an example of a method for obtaining the above toner particle will be described below, the present disclosure is not limited to the following method.

A method for producing a toner is not particularly limited, and a known method such as a pulverization method, a suspension polymerization method, a dissolution suspension method, an emulsion aggregation method, or a dispersion polymerization method can be used. Here, the toner is preferably produced by the method described below. In other words, the toner is preferably manufactured by an emulsion aggregation method using an aluminum-based aggregating agent.

The method for manufacturing the toner includes the following processes (1) to (3) in this order, for example:
(1) a dispersion process of preparing a binder resin fine particle dispersion containing a binder resin;
(2) an aggregation process of aggregating a binder resin fine particle contained in the binder resin fine particle dispersion to form an aggregate; and
(3) a fusion process of heating and fusing the aggregate.

In addition, the following processes (4) to (6) are preferably included in this order during or after the fusion process:
(4) a spheroidization process of further heating the aggregate by increasing a temperature;
(5) a cooling process of cooling the aggregate at a cooling rate of equal to or greater than 0.1° C./second; and
(6) an annealing process of heating and retaining the aggregate at a temperature equal to or greater than the crystallization temperature or the glass transition temperature of the binder resin.

Hereinafter, the emulsion aggregation method will be described in detail.

### Emulsion Aggregation Method

The emulsion aggregation method is a method in which an aqueous fine particle dispersion that is formed of a constituent material of a toner particle and sufficiently small in relation to a target particle diameter is prepared in advance, the fine particles thereof are aggregated in an aqueous medium until the diameter reaches a particle diameter of the toner particle, and a resin is fused by heating or the like to produce a toner particle.

In other words, the following processes, for example, are performed to produce the toner particle in the emulsion aggregation method. The toner particle is produced through a dispersion process of preparing a fine particle dispersion composed of a constituent material of a toner particle, an aggregation process of aggregating fine particles containing a constituent material of the toner particle and controlling a particle diameter until the particle diameter of the toner particle is obtained, a fusion process of subjecting a resin contained in the obtained aggregated particle for melt adhesion, a spheroidizing process of melting the toner particle by heating or the like and controlling a surface profile of a toner as needed, a subsequent cooling process, a metal removal process of filtering the obtained toner and removing excessive polyvalent metal ions, a filtration and washing process of washing the toner particle with ion exchange water or the like, and a process of removing moisture of the washed toner particle and drying the toner particle.

### Process of Preparing Resin Fine Particle Dispersion (Dispersion Process)

The resin fine particle dispersion can be prepared by a known method, but the method is not limited thereto. Examples of the known method include an emulsion polymerization method, a self-emulsification method, a phase inversion emulsification method in which an aqueous medium is added to a resin solution dissolved in an organic solvent to emulsify the resin, and a forced emulsification method in which a resin is forcibly emulsified by a high-temperature treatment in an aqueous medium without using an organic solvent.

Specifically, a binder resin is dissolved in an organic solvent in which the binder resin can be dissolved, and a surfactant or a basic compound is added thereto as needed. At that time, when the binder resin is a crystalline resin having a melting point, the resin only needs to be heated to a temperature equal to or higher than the melting point and dissolved. Subsequently, an aqueous medium is slowly added to precipitate a resin fine particle while stirring with a homogenizer or the like. Thereafter, the solvent is removed by heating or reducing the pressure to prepare an aqueous dispersion of resin fine particles. As the organic solvent used to dissolve the resin, any organic solvent can be used as long as it can dissolve the resin, and it is preferable to use an organic solvent that forms a uniform phase with water such as toluene from the viewpoint of curbing the generation of coarse powder.

The surfactant that may be used in the emulsification is not particularly limited, and examples thereof include an anionic surfactant such as a sulfuric acid ester salt-based surfactant, a sulfonate-based surfactant, a carboxylate-based surfactant, a phosphoric acid ester-based surfactant, or a soap-based surfactant; a cationic surfactant such as an amine salt-based surfactant and a quaternary ammonium salt-based surfactant; and a nonionic surfactant such as a polyethylene glycol-based surfactant, an alkylphenol ethylene oxide adduct-based surfactant and a polyhydric alcohol-based surfactant. The surfactants may be used alone or in combination of at least two kinds thereof.

Examples of the basic compound that may be used in the dispersion process include an inorganic base such as sodium hydroxide and potassium hydroxide; and an organic base such as ammonia, triethylamine, trimethylamine, dimethylaminoethanol and diethylaminoethanol. The basic compounds may be used alone or in combination of at least two kinds thereof.

In addition, a 50% particle diameter (D50) on a volume basis of binder resin fine particles in the aqueous dispersion of the resin fine particles is preferably 0.05 μm to 1.00 μm, and more preferably 0.05 μm to 0.40 μm. By adjusting the 50% particle diameter (D50) on a volume basis to the above range, it is easy to obtain toner particles having a volume-average particle diameter of 3 μm to 10 μm, which is a preferable volume-average particle diameter of toner particles. It should be noted that a dynamic light scattering particle size distribution analyzer Nanotrac UPA-EX150 (manufactured by Nikkiso Co., Ltd.) is used to measure the 50% particle diameter (D50) on a volume dispersion basis.

### Colorant Fine Particle Dispersion

A colorant fine particle dispersion may be used as needed. The colorant fine particle dispersion can be prepared by the following known method, but the method is not limited thereto. The colorant fine particle dispersion can be prepared by mixing a colorant, an aqueous medium, and a dispersing agent with a known mixing machine such as a stirrer, emulsifier, or disperser. As the dispersing agent used herein, a known dispersing agent such as a surfactant or a polymer dispersing agent may be used. Although both the dispersing agents, namely the surfactant and the polymer dispersing agent can be removed in a washing process, which will be described later, the surfactant is preferable from the viewpoint of washing efficiency.

Examples of the surfactant include an anionic surfactant such as a sulfuric acid ester salt-based surfactant, a sulfonate salt-based surfactant, a phosphate ester-based surfactant and a soap-based surfactant; a cationic surfactant such as an amine salt-based surfactant and a quaternary ammonium salt-based surfactant; and a nonionic surfactant such as a polyethylene glycol-based surfactant, an alkylphenol ethylene oxide adduct-based surfactant and a polyhydric alcohol-based surfactant. Among them, a nonionic surfactant or an anionic surfactant is preferable. A nonionic surfactant and an anionic surfactant may be used in combination. The surfactants may be used alone or in combination of at least two kinds thereof. The concentration of the surfactant in the aqueous medium is preferably 0.5% by mass to 5% by mass.

The content of the colorant fine particles in the colorant fine particle dispersion is not particularly limited, and is preferably 1% by mass to 30% by mass relative to the total mass of the colorant fine particle dispersion.

In addition, it is preferable that a dispersion particle diameter of the colorant fine particles in the aqueous dispersion of the colorant have a 50% particle diameter (D50) on a volume basis of not more than 0.5 μm from the viewpoint of the dispersibility of the colorant in the finally obtained toner. In addition, for the same reason, a 90% particle diameter (D90) on a volume basis is preferably not more than 2 μm. Note that the dispersion particle diameter of the colorant fine particles dispersed in the aqueous medium is measured with a dynamic light scattering particle size distribution analyzer (Nanotrac UPA-EX150: manufactured by Nikkiso Co., Ltd.).

Examples of the known mixing machine such as a stirrer, emulsifier, or disperser used when dispersing the colorant in the aqueous medium include an ultrasonic homogenizer, a jet mill, a pressure type homogenizer, a colloid mill, a ball mill, a sand mill, and a paint shaker. These mixing machines may be used alone or in combination.

### Release Agent (Aliphatic Hydrocarbon) Fine Particle Dispersion

A release agent fine particle dispersion may be used as needed. The release agent fine particle dispersion can be prepared by the following known methods, but is not limited to these methods.

The release agent fine particle dispersion can be produced by adding a release agent to an aqueous medium containing a surfactant, heating the resulting mixture to a temperature equal to or higher than the melting point of the release agent, and dispersing the mixture in the form of particle with a homogenizer (for example, “CLEARMIX W Motion” manufactured by M Technique Co., Ltd.) or a pressure discharge type disperser (for example, “Gaulin homogenizer” manufactured by Gaulin Corporation) having a strong shearing ability. It may also be cooled to below the melting point of the release agent as needed.

The dispersion particle diameter of the release agent fine particle dispersion in the release agent aqueous dispersion is preferably, as a 50% particle diameter (D50) on a volume distribution basis, 0.03 μm to 1.0 μm and more preferably 0.1 μm to 0.5 μm. It is preferable that a coarse particle of at least 1 μm be not present. It is possible to cause the release agent to be present in a finely distributed state, to cause an outmigration effect at the time of fixing to be expressed to the maximum extent, and to obtain satisfactory separability. Note that the dispersion particle diameter of the release agent fine particle dispersion dispersed in the aqueous medium can be measured by a dynamic light scattering particle size distribution analyzer (Nanotrac UPA-EX150: manufactured by Nikkiso Co., Ltd.).

### Mixing Process

In the mixing process, a mixed liquid obtained by mixing the resin fine particle dispersion, and as necessary, at least one of the release agent fine particle dispersion and the colorant fine particle dispersion is prepared. The mixing process can be performed using a known mixing machine such as a homogenizer or a mixer.

### Process of Forming Aggregate Particles (Aggregation Process)

In the aggregation process, fine particles contained in the mixed solution prepared in the mixing process are aggregated to form an aggregate having a target particle diameter. In this case, a flocculant is added and mixed, and at least one of the heating and mechanical power is applied as necessary and as appropriate to form an aggregate obtained by aggregating resin fine particle, and, if necessary, at least one of a release agent fine particle and a colorant fine particle.

Examples of the flocculant include an organic flocculant such as a cationic surfactant of a quaternary salt and polyethyleneimine; an inorganic metal salt such as sodium sulfate, sodium nitrate, sodium chloride, calcium chloride and calcium nitrate; an inorganic ammonium salt such as ammonium sulfate, ammonium chloride and ammonium nitrate; and an inorganic flocculant such as a divalent or higher metal complex. In addition, it is also possible to add an acid so as to cause soft aggregation by lowering the pH, and for example, sulfuric acid, nitric acid, or the like can be used.

Among these, using the aggregating agent containing an aluminum element facilitates introduction of an aluminum element to the toner particle surface. Specifically, aluminum sulfate or polyaluminum chloride, which are aluminum salts, can be suitably used.

The flocculant may be added in the form of either a dry powder or an aqueous solution dissolved in an aqueous medium, and in order to cause uniform aggregation, it is preferable to add the flocculant in the form of an aqueous solution. In addition, the addition and mixing of the flocculant are preferably performed at a temperature equal to or lower than a glass transition temperature or a melting point of the resin contained in the mixed solution. By performing mixing under these temperature conditions, aggregation proceeds relatively uniformly. The flocculant can be mixed into the mixed solution using a known mixing device such as a homogenizer or a mixer. The aggregation process is a process of forming an aggregate having a toner particle diameter in an aqueous medium. A volume-average particle diameter of the aggregates produced in the aggregation process is preferably 3 μm to 10 μm. The volume-average particle diameter can be measured using a particle size distribution analyzer (Coulter Multisizer III, manufactured by Beckman Coulter, Inc.) using the Coulter method.

### Process of Obtaining Dispersion Containing Toner Particles (Fusion Process)

In the fusion process, the dispersion containing the aggregate obtained in the aggregation process is first subjected to a stop of aggregation under stirring similar to the aggregation process. The aggregation is terminated by adding an aggregation terminating agent such as a base that can adjust a pH, a chelate compound, or an inorganic salt compound such as sodium chloride.

After the dispersion state of the aggregated particles in the dispersion becomes stable by the action of the aggregation terminating agent, the dispersion is heated to a temperature equal to or higher than the glass transition temperature or melting point of the binder resin, and the aggregated particles are fused to adjust the particle diameter to a desired particle diameter. Note that it is preferable that the 50% particle diameter (D50) on a volume basis of the toner particles be 3 μm to 10 μm.

### Process of Obtaining Toner Having Desired Surface Profile (Spheroidization Process)

During the fusion process or after the fusion process, the temperature is preferably further increased to perform a spheroidization process in which the toner particle is retained to a desired circularity or surface profile. A specific temperature of the spheroidization process is, for example, 90° C. or higher, preferably 92° C. or higher, and preferably 95° C. or lower. Examples of a heating time in the spheroidization process include heating times of at least 3 hours, at least 5 hours, and at least 8 hours. Although an upper limit is not particularly limited, the upper limit is, for example, equal to or less than 20 hours or equal to or less than 12 hours.

### Cooling Process

After the spheroidization process, it is preferable to carry out a cooling process of cooling the temperature of the obtained dispersion containing the toner particle by controlling the cooling rate to a temperature that is lower than the crystallization temperature or the glass transition temperature of the binder resin. Through the cooling process, formation of unevenness on the toner particle surface with a change in volume such as expansion or contraction of the material in the toner particle is curbed. A specific cooling rate is at least 0.1° C./second, preferably at least 0.5° C./second, more preferably at least 2° C./second, and still more preferably at least 4° C./second. Although the upper limit is not particularly limited, the upper limit is, for example, equal to or less than 100° C./second or equal to or less than 20° C./second.

### Annealing Process

After the cooling process, an annealing process of heating and retaining the temperature to be equal to or greater than the crystallization temperature or the glass transition temperature of the binder resin and in a case where a release agent is contained, to be equal to or less than the crystallization temperature of the release agent is preferably carried out. Since the above volume change can be further curbed through the annealing process, the occurrence of recesses on the toner particle surface can be curbed, and the circularity or surface profile can be controlled. A specific annealing temperature is from 45° C. to 75° C., preferably from 50° C. to 70° C., and still more preferably from 55° C. to 65° C. The heat treatment time in the annealing process is, for example, within 5 hours, preferably 2 to 4 hours.

### Post-Treatment Process

In the method of producing the toner, a post-treatment process such as a washing process, a solid-liquid separation process, or a drying process may be further performed, and a toner particle in a dried state is obtained by performing the post-treatment process.

### External Addition Process

In the external addition process, external addition treatment of the fine particle to the toner particle obtained through the drying process is performed. Other known fine particles may be used in combination as needed.

Next, a method for measuring each physical property according to the present disclosure will be described.

### Isolation Method of Fine Particle and Method for Measuring Content of Fine Particle Included in Toner

To 100 g of ion exchanged water, 0.50 g of Triton-X100 (manufactured by Kishida Chemical Co., Ltd.) is put to prepare a dispersion medium.
(1) 1.00 g of the toner is weighed exactly in a vial bottle, and the dispersion medium is added to be 10.00 g, and then left for 24 hours to prepare a sample liquid.
(2) The sample liquid is subjected to an ultrasonic homogenizer treatment to release the external additive from the toner and disperse the released external additive in the dispersion medium.

Ultrasound treatment device: Ultrasound homogenizer VP-050 (manufactured by TAITEC Corporation)

Microchip: Stepped microchip, tip diameter φ2 mm

Tip position of microchip: The central portion of the glass vial at a height of 5 mm from the bottom surface of the vial

Ultrasound conditions: Intensity of 30% for 180 mins. At this time, ultrasonic waves are applied while cooling the vial with ice water so that the temperature of the dispersion should not rise.
(3) The toner particle in the sample solution is separated from the dispersion medium (filtrate) in which the external additive is dispersed by suction filtration (10 μm membrane filter).
(4) The filtered toner particle is collected and the dispersion medium is added again to obtain 10.00 g of solution, and then (2) and (3) above are repeated 10 times in total to collect all filtrate.
(5) In a case where other external additives are externally added, the collected filtrate is set in a centrifugal separator to separate other external additives and collect the fine particle.
(6) The collected fine particle is sufficiently dried in a vacuum drier at 60° C. for 24 hours to isolate the dried inorganic fine particle.

The mass of the fine particle included in 1.00 g of toner is obtained by measuring the mass of the dried fine particle. Then, a value obtained by multiplying the mass by 100 is regarded as the content (% by mass) of the fine particle in the toner.

### Isolation Method of Toner Particle

The toner particle obtained by repeating filtration 10 times in total in the isolation method of the fine particle and (4) of the method for measuring the content of the fine particle included in the toner is collected and is sufficiently dried at 45° C. for 24 hours to thereby isolate the toner particle.

Measurement of Amount C_{Al} of Aluminum Element that is Present on Toner Particle Surface

Signal intensity obtained by TOF-SIMS is quantified using standard samples to calculate the amount C_{Al} of presence.

As the standard samples, toner particles produced to have different amounts of aluminum elements that are present on their surfaces by a procedure shown in examples are used. The amounts of aluminum elements that are present in these standard samples are quantified in advance by XPS, the same samples are then measured by TOF-SIMS, and a calibration curve of TOF-SIMS is created. Specifically, standard samples in which the ratios (atomic %) of the aluminum atoms are 1.0×10⁻³, 1.0×10⁻², 1.0×10⁻¹, and 2.0 are created, and the calibration curve is created. Hereinafter, each of the measuring method of XPS and the measuring method of TOF-SIMS will be shown.

Quantification of Amounts of Aluminum Elements that are Present in Standard Samples by XPS

The contents of aluminum elements that are present on the surfaces of the standard samples to create the calibration curve can be measured by X-ray photoelectron spectroscopy (XPS). The device and the measurement conditions of XPS are as follows.
Device used: Quantum 2000 manufactured by ULVAC-PHI, Incorporated
Sample preparation: Fill holes (1 mmΦ, 1 mm depth) formed in a sample table with the standard samples
Analytical method: Narrow analysis
Measurement Conditions:
X-ray source: Al—Kα
X-ray conditions: Beam diameter of 100 μm, 25 W, 15 kV
Photoelectronic intake angle: 45°
PassEnergy: 58.70 eV
Measurement range: φ100 μm

As an analysis method, a peak originated from a C—C bond of a carbon is orbital is corrected to 285 eV. Then, the ratios (atomic %) of aluminum atoms in the vicinity of the surfaces of the standard samples are calculated using a relative sensitivity factor provided by ULVAC-PHI, Incorporated from peak areas originated from an aluminum 2p orbital in which peak tops are detected in a range from 72.5 eV to 74.6 eV.

Measurement of Aluminum Element that is Present on Toner Particle Surface by TOF-SIMS and Quantization Using Standard Samples

The measurement of the aluminum element that is present on the toner particle surface is performed by evaluating a positive ion using a time-of-flight secondary ion mass spectrometry (TOF-SIMS) on the toner particle. The device used and measurement conditions are shown below.
Measurement device: nanoTOF II (product name, manufactured by ULVAC-PHI, Incorporated)
Primary ion species: Bi³⁺⁺
Accelerating voltage: 30 kV
Primary ion current: 0.05 pA
Repetition frequency: 8.2 kHz
Raster mode: Unbunch
Raster size: 20 μm×20 μm, 256×256 pixels
Measurement mode: Positive
Neutralization electron gun: Used
Measurement time: 600 seconds
Sample preparation: Toner particle is fixed to an indium sheet
Sample pretreatment: None

In order to obtain a TOF-SIMS mapping image with high resolution and high mass resolution, it is preferable to set a short pulse width. Aluminum ion detection intensity at a part where the toner particle surface is exposed is calculated using standard software (TOF-DR) manufactured by ULVAC-PHI, Incorporated. The part where the toner particle surface is exposed can be specified using SEM by “SEM observation method of toner particle” below on the same measurement region.

On the other hand, TOF-SIMS measurement is performed under the same conditions on the standard samples as well, and calibration curve is created from the detection intensity and the ratios of aluminum atoms in the vicinity of the surfaces of the standard samples. The obtained calibration curve can be used to calculate the amount C_{Al} of aluminum elements that are present on the toner particle surfaces from the detection intensity of the aluminum ions on the toner particle surfaces.

### SEM Observation Method of Toner Particle

The SEM device and the observation conditions are as described below.
Device used: ULTRA PLUS manufactured by Carl Zeiss Microscopy
Accelerating voltage: 1.0 kV
WD: 2.0 mm
Aperture size: 30.0 μm
Detection signal: EsB (energy selective backscattered electron)
EsB grid: 800 V
Observation magnification: 50,000 times
Contrast: 63.0±5.0% (reference value)
Brightness: 38.0±5.0% (reference value)
Image size: 1024×768 pixels
Pretreatment: The toner particle is sprayed onto carbon tape (but not vapor-deposited)

Contrast and brightness are set as appropriate in accordance with the state of the device used. Also, an acceleration voltage and EsB Grid are set to achieve items such as acquisition of structure information of the outermost surfaces of the toner particles, prevention of charge-up of undeposited samples, and selective detection of backscattered electrodes with high energy. The field of view of observation is set in the region where measurement has been carried out by TOF-SIMS.

### Method for Measuring Surface Treatment Material of Fine Particle

TOF-SIMS analysis is performed on the fine particle, which has been isolated by the method described above in the isolation method of the toner particle, by the method described above in the measurement of the aluminum element that is present on the toner particle surface by TOF-SIMS and the quantization using the standard samples. It is possible to specify the surface treatment material of the fine particle from fragment information obtained at this time. Note that in a case where the fine particle of the material can be obtained alone, the fine particle may be used as a sample.

### Method for Measuring Number-Average Particle Diameter (D1) of Fine Particle

The number-average particle diameter (D1) of the primary particles of the fine particles is measured using a scanning electron microscope “S-4800” (product name; manufactured by Hitachi, Ltd.).

The toner with the fine particle externally added thereto is observed, the major diameters of the primary particles of 100 fine particles are randomly measured in a field of view enlarged to 200 thousand times at maximum, and the number-average particle diameter (D1) is then obtained. The observation magnification is adjusted as appropriate in accordance with the sizes of the fine particles.

Note that as for the distinction between the fine particles and other external additives, the fine particles covered with aluminum hydroxide are specified by identifying substrates of the fine particles, which will be described later, and the method for measuring the coverage ratio of the fine particles with aluminum hydroxide, and the particles with the surface form are determined to be the fine particles.

### Method for Measuring X-Ray Diffraction Pattern of Fine Particle

The crystal system of fine particle can be identified by X-ray diffraction analysis of the fine particle taken from the toner.

The X-ray diffraction measurement uses a measuring instrument, “RINT-TTRII” (manufactured by Rigaku Corporation), and control software and analysis software attached to the instrument. The measurement conditions are as described below.

$$X - ray : CU / 50 kV / 300 mA$$

Goniometer: Rotor horizontal goniometer (TTR-2)
Attachment: Standard sample holder
Divergent slit: Release
Divergence vertical restriction slit: 10.00 mm
Scattering slit: Opened
Light-receiving slit: Opened
Counter: Scintillation counter
Scanning mode: Continuous
Scanning speed: 4.0000°/min
Sampling width: 0.0200°
Scanning axis: 2θ/deg
Scanning range: 3.0000° to 60.0000°

The resulting spectra are analyzed by software attached to the device to identify crystalline structures. In a case where the fine particle is composed of amorphous silica and aluminum hydroxide, no clear peaks are detected. Meanwhile, in a case where the aluminum component contains aluminum oxide (Al₂O₃), clear peaks reflecting the alumina crystalline structure are detected.

### Method for Measuring Weight-Average Particle Diameter (D4) and a Number-Average Particle Diameter (D1) of Toner

A weight-average particle diameter (D4) and a number-average particle diameter (D1) of the toner or the toner particles are measured with 25,000 effective measurement channels using a precision particle size distribution measuring device “Coulter Counter Multisizer 3” (registered trademark, manufactured by Beckman Coulter, Inc.) by a pore electrical resistance method provided with an aperture tube of 100 μm and a dedicated software “Beckman Coulter Multisizer 3 Version 3.51” (manufactured by Beckman Coulter, Inc.) attached for setting measurement conditions and analyzing measurement data, and the measurement data is analyzed and calculated.

As an electrolyte aqueous solution used for the measurement, a solution prepared by dissolving special grade sodium chloride in ion exchange water to a concentration of about 1% by mass, for example, “ISOTON II” (commercially available from Beckman Coulter, Inc.) can be used.

Before the measurement and the analysis, the dedicated software is set as described below.

On the “standard measurement method (SOM) change screen” of the dedicated software, the total count number in the control mode is set to 50000 particles, the number of times of measurements is set to one, and the Kd value is set to a value obtained using “standard particle 10.0 μm” (manufactured by Beckman Coulter, Inc.). When the threshold/noise level measurement button is pressed, the threshold and the noise level are automatically set. In addition, the current is set to 1600 μA, the gain is set to 2, the electrolyte solution is set to ISOTON II, and the box “flush aperture tube after measurement” is checked.

In the “Setting screen for converting pulse to particle diameter” in the dedicated software, set the bin interval to the logarithmic particle diameter, set the particle diameter bin to 256 particle diameter bin, and set the particle diameter range to from 2 μm to 60 μm.

The specific measurement method is as follows.
(1) 200 ml of electrolyte aqueous solution described above is put into a 250 ml round-bottom glass beaker dedicated to Multisizer 3, which is set on a sample stand, and stirring rods are stirred counterclockwise at 24 rotations/sec. Then, contaminants and air bubbles in the aperture tube are removed by the function “flush aperture tube” in the dedicated software.
(2) The aqueous electrolytic solution: 30 ml is put into a 100 ml flat-bottom glass beaker. To this solution, 0.3 ml of a diluted solution prepared by diluting “Contaminon N” (a 10% by mass aqueous solution of a neutral detergent with pH 7 for washing precision measurement instruments, including a nonionic surfactant, an anionic surfactant, and an organic builder, manufactured by Wako Pure Chemical Industries, Ltd.) with ion exchange water to 3 times by mass is added as a dispersing agent.
(3) Two oscillators with an oscillating frequency of 50 kHz and with phases shifted by 180 degrees are incorporated, a predetermined amount of ion exchange water is put into a water tank of an ultrasonic disperser “Ultrasonic Dispersion System Tetora150” with an electrical output of 120 W (commercially available from Nikkaki Bios Co., Ltd.), and about 2 ml of Contaminon N described above is added to this water tank.
(4) The beaker in (2) is set in a beaker fixing hole of the ultrasonic disperser, and the ultrasonic disperser is operated. The height position of the beaker is adjusted so that the resonance state of the liquid level of the electrolyte aqueous solution in the beaker is maximized.
(5) While the electrolyte aqueous solution in the beaker in (4) is irradiated with ultrasonic waves, 10 mg of the toner is added little by little to the electrolyte aqueous solution and dispersed. Then, the ultrasonic dispersion treatment is further continued for 60 seconds. Upon the ultrasonic dispersion, the water temperature in the water tank is appropriately adjusted from 10° C. to 40° C.
(6) The electrolyte aqueous solution in (5) in which the toner is dispersed is added dropwise to the round bottom beaker in (1) installed in a sample stand using a pipette, and a measurement concentration is adjusted to 5%. Then, the measurement is performed until the number of measurement particles reaches 50,000.
(7) Measurement data is analyzed with the dedicated software attached to the device, and the weight-average particle diameter (D4) and the number-average particle diameter (D1) are calculated. Note that “arithmetic diameter” on the analysis/number statistical value (arithmetic average) screen and “arithmetic diameter” on the analysis/volume statistical value (arithmetic average) screen when graph/number % and graph/volume % are set by the dedicated software are the number-average particle diameter (D1) and the weight-average particle diameter (D4), respectively.

### Identification of Pigment Yellow 74 (Compound Represented by Formula (Y))

Isolation Method of Pigment Yellow 74 (Compound Represented by Formula (Y)) from Toner Particle

To 3 ml of chloroform, 100 mg of toner particle is dissolved. Next, an insoluble component is removed by suction-filtration with a syringe to which a sample treatment filter (with a pore size from 0.2 μm to 0.5 μm; for example, Maishoridisk H-25-2 (manufactured by Tosoh Corporation) is used) is attached.

A soluble component is introduced into preparative HPLC (device: LC-9130 NEXT preparative column [60 cm] manufactured by Japan Analytical Industry Co., Ltd., exclusion limit: 20000, 70000; these two are connected), and a chloroform eluent is fed thereto. Once a peak can be observed in obtained chromatograph display, preparative separation is performed for a retention time to show a yellow color. An obtained fraction solution is dried and solidified, thereby preparatively separating candidates for the compound represented by Formula (Y).

### Identification of Compound Represented by Formula (Y)

For identification of the compound represented by Formula (Y), a pyrolysis gas chromatography mass spectrometer (hereinafter, also referred to as “pyrolysis GC/MS”) and NMR are used.

The pyrolysis GC/MS is used for analysis of the type of a constituent compound of each sample. The mass spectrum of a component of a decomposition product of the sample generated when the sample is thermally decomposed at 550° C. to 700° C. is analyzed to thereby identify the type of the constituent compound. Specific measurement methods are as follows.
Measurement Conditions of Pyrolysis GC/MS
Pyrolysis device: JPS-700 (Japan Analytical Industry CO. Ltd.)
Decomposition temperature: 590° C.
GC/MS device: Focus GC/ISQ (Thermo Fisher)
Column: HP-5MS with a length of 60 m, an inner diameter of 0.25 mm, and a film thickness of 0.25 μm
Inlet temperature: 200° C.
Flow pressure: 100 kPa
Split: 50 mL/min.
MS ionization: EI
Ion source temperature: 200° C. Mass Range 45 to 650

Furthermore, a detailed molecular structure of the sample is measured by solid 1H-NMR. The structure is determined using nuclear magnetic resonance spectroscopy (1H-NMR) [400 MHz, CDCl₃, room temperature (25° C.)].
Measuring apparatus: FT NMR apparatus JNM-EX400 (manufactured by JEOL Ltd.)
Measurement Frequency: 400 MHz
Pulse Condition: 5.0 μs
Frequency Range: 10,500 Hz
Accumulation Count: 1024 times
   Identification of Substrate of Fine Particle and Method for Measuring Coverage Ratio of Fine Particle with Aluminum Hydroxide

Elements included in the substrate of the fine particle can be identified from an element mapping image obtained by energy-dispersive spectroscopy (STEM-EDS) using a scanning transmission electron microscope.

In EDS element mapping measurement, element mapping images can be measured with high sensitivity, even with trace elements, by using a silicon drift detector having a large detection element area. By performing statistical analysis on the spectral data of each pixel obtained by EDS element mapping measurement, a principal component mapping in which pixels having similar spectra are extracted can be obtained, and mapping in which the components are identified can be performed.

The coverage ratio of the substrate with the aluminum element included in aluminum hydroxide (aluminum hydroxide coverage ratio) can be calculated from an element mapping image of the fine particle substrate and an element mapping image of aluminum. A specific measurement procedure is as follows.

The sample for observation is prepared by the following procedures:

The sample for observation is produced by ultrasonically dispersing 10 mg of fine particle isolated by the method described in the isolation method of the fine particle in 2 ml of isopropyl alcohol, adding the thus obtained liquid dropwise to a Cu grid mesh with a support film, and evaporating the solvent. Note that in a case where the fine particle of the material can be obtained alone, the fine particle may be used as a sample.

STEM-EDS mapping analysis is performed in the following devices and conditions.
Scanning transmission electron microscope; JEM-2800 manufactured by JEOL Ltd.
EDS detector; JED-2300 T dry SD100GV detector (detector element area: 100 mm²) available from JEOL Ltd.
EDS Analyzer; NORAN System 7 manufactured by Thermo Fisher Scientific Inc.
STEM-EDS Conditions
   Acceleration voltage of STEM: 200 kV
   Magnification: 1,000,000 times
   Probe size: 0.5 nm
STEM image size; 1024×1024 pixels (EDS element mapping images at the same location are acquired.)
EDS mapping size; 256×256 pixels, Dwell time; 30 μs, Accumulation Count: 100 frames
After the end of the measurement, quantitative mapping is acquired by the following analytical process.
   Kernel size 3×3
   Quantitative map settings: High (slow)
   Filter fit type: High precision (slow)

An Al—K-ray mapping image and an EDS mapping image of characteristic X-rays of the fine particle substrate are obtained by the above-described STEM-EDS analysis. Note that in a case where the fine particle has aluminum hydroxide on the substrate surface and the fine particle does not contain alumina, an EDS mapping image by STEM-EDS analysis is used. In a case where the fine particle contains alumina and the like, mapping analysis by STEM-EELS, which will be described later, is performed.

Each of an Al—K ray mapping image and an EDS mapping image of characteristic X-rays of the fine particle substrate is obtained in the field of view of observation. The mapping image obtained in STEM-EDS mapping is analyzed with image analysis software ImageJ. It is possible to calculate the aluminum hydroxide coverage ratio (%) of the fine particle by measuring the number S3 of pixels that the element of the fine particle substrate in the fine particle occupies and the number S4 of pixels that aluminum occupies from the mapping image and calculating S4/S3×100.

Note that in a case where the substrate contains aluminum like silica-alumina, measurement by STEM-EELS is performed instead of STEM-EDS. Thus, a mapping image in which alumina and aluminum hydroxide are distinguished from each other is obtained. EELS used for the measurement is an EELS detector GIF Tridiem manufactured by Gatan, an EF mapping image of an Al—K terminal (1486.6 eV) is acquired by the three-window method, and each of the fine particle substrate and the aluminum hydroxide coating is mapped.

Similarly to the above description, it is possible to calculate the aluminum hydroxide coverage ratio (%) of the fine particle can be calculated by measuring the number S3 of pixels occupied by the element of the fine particle substrate in the fine particle and the number S4 of pixels occupied by aluminum included in aluminum hydroxide from the mapping image and calculating S4/S3×100.

### Confirmation of Inclusion of Inorganic Fine Particle Embedded Region on Toner Particle Surface, Method for Measuring Embedding Rate, and Method for Identifying Element Contained in Inorganic Fine Particle

Whether or not a region where an inorganic fine particle is embedded is present on the toner particle surface can be evaluated by obtaining a ratio between an area A of the inorganic fine particle that is present on the contour of the toner particle section and within 30 nm from the contour of the toner particle and an area B of the inorganic fine particle that is present outside the contour of the section.

The area of the inorganic fine particle that is present on the contour of the section of the toner particle and within 30 nm from the contour of the toner particle is calculated using a scanning transmission electron microscope (STEM).

The section of the toner observed with STEM is produced as follows.

Hereinafter, a procedure for producing the cross section of the toner will be described.

First, in order to produce the toner section, mixed powder obtained by an embedding resin and the toner is produced. As a resin for embedding the toner, a resin containing a metal element that is not contained in the toner is selected. Although the resin containing a metal element that is not contained in the toner is not particularly limited as long as the resin has moderate deformability at a room temperature, it is possible to suitably use long-chain fatty acid metal salts, for example. Among the long-chain fatty acid metal salts, zinc stearate or magnesium stearate having a relatively low melting point can be more suitably used.

With respect to 1 part by mass of toner, 100 parts by mass of embedding resin is weighed and is put into a sample bottle. Next, the above-mentioned sample bottle is shaken at 500 rpm for 30 minutes to produce mixed powder by mixing the toner with the embedding resin. Hereinafter, a case where zinc stearate is used as an embedding resin will be described.

Next, the mixed powder is pressurized at 20 Pa for 10 minutes to produce a pellet-like press-molded piece (hereinafter, referred to as a pellet).

The pellet is cut at a cutting speed of 0.6 mm/s with an ultrasonic ultramicrotome (Leica, UC7) to produce the toner section.

Next, the toner is cut to have a film thickness of 500 nm to produce a thin piece sample of the toner section. It is possible to obtain the toner section by cutting the toner by such a method.

The toner section is observed at an acceleration voltage of 100 kV using JEM-2800 (manufactured by JEOL Ltd.). A clear image is acquired with a STEM probe size of 1 nm and an image size of 512×512 pixels. The image magnification is set to 100,000 times, and image acquisition is performed such that at least ¼ or more of the circumference of the section in one toner particle falls within the image. As a toner section from which an image is to be acquired, a toner section with a major diameter of 0.9 times to 1.1 times of the number-average particle diameter (D1) of the toner is selected.

In parallel with the above-described shape image acquisition, mapping analysis of the element included in the observation image is performed using an energy-dispersive X-ray spectroscopy (EDS). As the element to be measured, elements contained in the toner and the embedding resin are selected without excess or deficiency. The resolution of mapping is 256×256 pixels, and analysis is performed at 0.01 μm/pixel. It is possible to identify the element contained in the inorganic fine particle from the element mapping information at this time.

The area of the inorganic fine particle that is present on the contour of the toner particle section and within 30 nm from the contour of the toner particle section is derived by performing image analysis on the image obtained for the above-described element analysis using the image processing software ImageJ.

Since the cut film thickness of 500 nm is sufficiently thin relative to an ordinary toner, it is possible to determine that the region where the metal element included only in the embedding resin (a zinc element in a case where zinc stearate is used) is detected is outside the toner. On the other hand, since an ordinary external additive is smaller than the cut film thickness of 500 nm, each of a region that is present inside the toner and a region that is present outside the toner and is included in the embedding resin is detected as in the FIGURE.

In other words, both the metal element included only in the embedding resin and the element of the external additive are detected in the external additive region that is present outside the contour of the toner particle section. On the other hand, the metal element included only in the embedding resin is not detected in the external additive that is present on the contour of the toner particle section and inside the toner particle while the element of the external additive is detected therein.

If the above-described method is used, the area A (pixel) of the inorganic fine particle that is present on the contour of the toner particle section and within 30 nm from the contour of the toner particle section can be defined as follows.

A (pixel)=“The number of pixels that are present in a region within 30 nm from the contour of the toner particle section toward the center of gravity (geometric center) of the toner particle, in which the element originated from the inorganic fine particle is detected while the metal element that is included only in the embedding resin is not detected.

It should be noted that the measurement regarding whether or not the distance from the contour of the toner particle section is within 30 nm can be performed by the following procedure using ImageJ. First, an element mapping image of the metal element included only in the embedding resin is opened with ImageJ. Next, the scale length of 1 pixel on the image is set. In a case where a scale bar is displayed on the image, it is possible to set the length of the scale on the image in Set Scale of the Analyze tab by overlapping with Straight Line of the Straight tab.

Next, an option of 8 bits is selected in Type of the Image tab, the image is converted into a monochromatic image, and smoothing processing is then performed using Smooth in the Process tab. Then, the image is binarized by opening Threshold of Adjust in the Image tab to obtain a binary image. As a binarization condition, Default is selected. It is possible to distinguish the region where the metal element included only in the embedding resin is detected from the region where such a metal element is not detected through this procedure. It is possible to measure whether the distance from the contour of the toner particle section is within 30 nm by causing the obtained binary image and the STEM shape image to overlap each other and depicting a line segment corresponding to 30 nm from the contour of the toner particle section to the center of gravity (geometric center) with Straight Line in the Straight tab.

In addition, the area B (pixel) of the inorganic particle that is present outside the contour of the toner particle section can be defined as follows.

B (Pixel)=“the number of pixels in which both the element originated from the inorganic fine particle and the metal element included only in the embedding resin are detected”

The area A (pixel) of the inorganic fine particle that is present on the contour of the toner particle section and within 30 nm from the contour of the toner particle and the area B (pixel) of the inorganic fine particle that is present outside the contour of the section are calculated through the above procedure. Then, A/(A+B)×100(%) is calculated. The value of A/(A+B)×100(%) is calculated for 100 inorganic fine particles observed, and an arithmetic average value thereof is regarded as the embedding rate. In a case where the embedding rate is equal to or greater than 50%, it is determined that the toner has a region where the inorganic fine particle is embedded on the toner particle surface.

### Method for Measuring Weight-Average Molecular Weight Mw and Number-Average Molecular Weight Mn

The molecular weights of samples such as a polyester resin, crystalline polyester, and styrene acrylic resin are measured as follows by gel permeation chromatography (GPC).

First, each sample is dissolved in tetrahydrofuran (THF). In the case of the polyester resin or the styrene acrylic resin, the polyester resin or the styrene acrylic resin is dissolved in THF at a room temperature over 24 hours. In the case of a crystalline polyester, THF is warmed to 40° C. and the crystalline polyester is dissolved therein, and then left for 24 hours.

The solution in which each sample is dissolved is filtrated through a solvent-resistant membrane filter “Maishoridisk” (manufactured by Tosoh Corporation) with a pore diameter of 0.2 μm to thereby obtain a sample solution. It should be noted that the sample solution is adjusted so that the density of the component soluble in THE be 0.8% by mass. The sample solution is used to perform measurement under the following conditions.
Apparatus: HLC8120GPC (detector: RI) (manufactured by Tosoh Corporation)
   Column: Seven connected Shodex KF-801, 802, 803, 804, 805, 806, and 807 columns (manufactured by Showa Denko)
Eluent: Tetrahydrofuran (TIF)
   Flow Rate: 1.0 ml/min.
   Oven temperature: 40.0° C.
   Sample Injection Amount: 0.10 ml

In the calculation of the molecular weight of the sample, a molecular weight calibration curve created using a standard polystyrene resin (for example, trade name “TSK standard polystyrene F-850, F-450, F-288, F-128, F-80, F-40, F-20, F-10, F-4, F-2, F-1, A-5000, A-2500, A-1000, and A-500” manufactured by Tosoh Corporation) is used.

### Measurement of Acid Value and Hydroxyl Value

The acid value and the hydroxyl value of each resin can be measured by the following procedure.

An acid value is the number of milligrams of potassium hydroxide required to neutralize an acid contained in 1 gram of a sample. The acid value of the resin is measured in accordance with JIS K 0070-1992.

Also, the hydroxyl value is the number of mg of potassium hydroxide required to neutralize acetic acid bonded to a hydroxyl group when 1 g of sample is acetylated. The hydroxyl value is measured in accordance with JIS K 0070-1992.

### EXAMPLES

The further details of the present disclosure will be described below with reference to Examples and Comparative Examples, but the present disclosure is not limited to these. In the unit “part(s)” used in Examples are on a mass basis unless otherwise specified.

### Manufacturing of Polyester A-1

Bisphenol A ethylene oxide 2 mol adduct: 27 parts by mole
Bisphenol A propylene oxide 2 mol adduct: 73 parts by mole
Terephthalic acid: 82 parts by mole
Fumaric acid: 5 parts by mole
Dodecenylsuccinic acid: 10 parts by mole
Trimellitic acid: 3 parts by mole

The monomers were added to a flask equipped with a stirring device, a nitrogen inlet tube, a temperature sensor, and a rectifying column, the temperature was raised to 190° C. over 1 hour, and uniform stirring in the reaction system was confirmed. Relative to 100 parts of these monomers, 1.0 part of tin distearate was added. The temperature was further raised from 190° C. to 245° C. over 5 hours while generated water was distilled off, and a dehydration condensation reaction was further performed at 245° C. for 2 hours. As a result, polyester A-1 with a glass transition temperature of 61.5° C., an acid value of 7 mgKOH/g, a hydroxyl value of 21 mgKOH/g, Mₙ of 4500, and M_{w}/Mₙ of 5.8 was obtained.

### Manufacturing of Polyester A-2

In the manufacturing of the polyester A-1, a similar operation was performed using the monomers described below.
Bisphenol A-ethylene oxide 2 mol adduct: 25 parts by mole
Bisphenol A propylene oxide 2 mol adduct: 75 parts by mole
Isophthalic acid: 90 parts by mole
Dodecenylsuccinic acid: 10 parts by mole

As a result, a polyester A-2 having a glass transition temperature of 58.9° C., an acid value of 5 mg KOH/g, a hydroxyl value of 26 mg KOH/g, Mₙ of 5200 and M_{w}/Mₙ of 6.5 was obtained.

### Preparation of Resin Particle Dispersion of Polyester A-1

Polyester A-1: 100 parts
Methyl ethyl ketone: 50 parts
Isopropyl alcohol: 20 parts

The vessel was charged with the above methyl ethyl ketone and isopropyl alcohol. After that, the polyester A-1 was gradually input, stirred, and completely dissolved to obtain a polyester A-1 solution. The container containing the polyester A-1 solution was set to 65° C., and a 10% aqueous solution of ammonia was gradually added dropwise while the solution was stirred to obtain 5 parts thereof, and 230 parts of ion exchanged water was gradually added dropwise at a speed of 10 ml/min to cause phase-inversion emulsification. Furthermore, desolvation was performed in an evaporator under a reduced pressure to obtain a resin particle dispersion of the polyester A-1.

The volume-average particle diameter of the resin particle included in the resin particle dispersion was 130 nm. In addition, the resin particle solid content was adjusted to 20% by mass with ion exchanged water.

### Preparation of Resin Particle Dispersion of Polyester A-2

A resin particle dispersion of the polyester A-2 was obtained similarly to the manufacturing to prepare the resin particle dispersion of the polyester A-1 other than that the polyester A-1 was changed to the polyester A-2. The volume-average particle diameter of the resin particle included in the resin particle dispersion was 110 nm. In addition, the resin particle solid content was adjusted to 20% by mass with ion exchanged water.

### Manufacturing of Crystalline Polyester B-1

1,10-decanedicarboxylic acid: 100 parts by mole
1,9-Nonanediol: 100 parts by mole
0.8 parts by mass of tin dioctylate as a catalyst with respect to the total amount of acid and alcohol

The above-described materials were put in a heated and dried reaction tank equipped with a nitrogen inlet tube, a dehydration tube, a stirrer, and a thermocouple, then nitrogen gas was introduced into the vessel to keep the inside in an inert atmosphere, and the temperature was raised. After that, stirring was performed at 170° C. for 6 hours. Then, the temperature was gradually raised to 230° C. under reduced pressure while continuing stirring and retained for an additional 3 hours. After a viscous state was achieved, the mixture was air-cooled, and the reaction was terminated.

As a result, crystalline polyester B-1 with an acid value of 4.0 mgKOH/g, a melting point of 74° C., and Mn: 11000, Mw/Mn: 2.0 was obtained.

### Manufacturing of Crystalline Polyester B-2

In the manufacture of crystalline polyester B-1, similar operations were performed using the monomers described below.
1,10-Decanedicarboxylic acid: 100 parts by mole
1,6-Hexanediol: 100 parts by mole

As a result, crystalline polyester B-2 with an acid value of 4.5 mgKOH/g, a melting point of 68° C., Mn: 10000, Mw/Mn: 2.3 was obtained.

### Preparation of Resin Particle Dispersion of Crystalline Polyester B-1

Crystalline Polyester B-1: 100 parts
Methyl ethyl ketone: 50 parts
Isopropyl alcohol: 20 parts

The vessel was charged with the above methyl ethyl ketone and isopropyl alcohol. After that, the above described crystalline polyester B-1 was gradually input, stirred, and completely dissolved to obtain a crystalline polyester B-1 solution. The container containing the crystalline polyester B-1 solution was set to 40° C., and a 10% aqueous solution was gradually added dropwise while the solution was stirred to obtain 3.5 parts thereof, and 230 parts of ion exchanged water was further gradually added dropwise at a speed of 10 ml/min to cause phase inversion emulsification. Furthermore, desolvation was performed in an evaporator under a reduced pressure to obtain a resin particle dispersion of the crystalline polyester B-1.

The volume-average particle diameter of the resin particle of the resin particle dispersion was 150 nm. In addition, the resin particle solid content was adjusted to 20% by mass with ion exchanged water.

### Preparation of Resin Particle Dispersion of Crystalline Polyester B-2

The resin particle dispersion of polyester B-2 was obtained similarly to the manufacturing to prepare the resin particle dispersion of the crystalline polyester B-1 other than that polyester B-1 was changed to polyester B-2. The volume-average particle diameter of the resin particle included in the resin particle dispersion was 110 nm. In addition, the resin particle solid content was adjusted to 20% by mass with ion exchanged water.

### Preparation of Coloring Agent Particle 1 Dispersion

Pigment Yellow 74: 35 parts
Ionic surfactant Neogen RK (manufactured by Daiichi Kogyo Co., Ltd.): 5 parts
Ion exchanged water: 160 parts

The above-described components were mixed and dispersed using a homogenizer (ULTRA-TURRAX manufactured by IKA) for 10 minutes, and dispersion treatment was then performed for 20 minutes at a pressure of 250 MPa using an ultimizer (counter collision-type wet grinder: manufactured by Sugino Machine Limited), thereby obtaining a coloring agent particle dispersion in which the volume-average particle diameter of the coloring agent particle was 120 nm and the solid content was 20% by mass.

### Preparation of Coloring Agent Particle 2 Dispersion

A coloring agent particle 2 dispersion was obtained similarly to the preparation of the coloring agent particle 1 dispersion other than that Pigment Yellow 74 was changed to Pigment Yellow 83. The volume-average particle diameter of the particle included in the dispersion of the coloring agent particle was 140 nm, and the solid content was 20% by mass.

### Preparation of Release Agent Particle Dispersion

Release agent (hydrocarbon wax, melting point: 79° C.): 15 parts
Ionic surfactant Neogen RK (manufactured by Daiichi Kogyo Co., Ltd.): 2 parts
Jon exchanged water: 120 parts

The above substances were heated to 100° C., were sufficiently dispersed with ULTRA-TURRAX T50 manufactured by TKA, and were warmed to 115° C. by a pressure ejection-type Gaulin homogenizer, and dispersion treatment was performed thereon for 1 hours, thereby obtaining a release agent particle dispersion with a volume average particle diameter of 160 nm and solid content of 20% by mass.

### Manufacturing of Fine Particle Substrate 1

To a 3 L glass reactor equipped with a stirrer, a dropping funnel, and a thermometer 687.9 g of methanol, 42.0 g of pure water, and 47.1 g of 28% by mass ammonia water were input and were mixed. The temperature of the obtained solution was adjusted to 35° C., and simultaneous addition of 1100.0 g (7.23 mol) tetramethoxysilane and 395.2 g of 5.4% by mass ammonia water was started while the solution was stirred. Tetramethoxysilane was added dropwise over 5 hours and ammonia water was added dropwise over 4 hours.

After the dropwise addition ended, the stirring was further continued for 0.2 hours to perform hydrolysis, thereby obtaining a methanol-water dispersion of a hydrophilic spherical sol-gel silica fine particle.

Then, an ester adapter and a cooling pipe were attached to the glass reactor, and the above-described dispersion was heated to 65° C. to distill methanol. Thereafter, the same amount of pure water as the amount of distilled methanol was added. The dispersion was dried at 80° C. at a reduced pressure. The obtained silica particle was heated at 400° C. for 10 minutes in a constant-temperature tank. The thus obtained silica fine particle (untreated silica) was subjected to pulverization treatment by a pulverizer (manufactured by Hosokawa Micron Corporation).

Thereafter, 50 g of silica particle was put into a polytetrafluoroethylene inner cylinder stainless steel autoclave with an inner volume of 1000 mL. After the inside of the autoclave was replaced with nitrogen gas, 0.5 g of hexamethyldisilazane and 0.1 g of water were uniformly sprayed in the form of mist to the silica particle using a two-fluid nozzle while a stirring blade attached to the autoclave was rotated at 400 rpm. After the stirring for 30 minutes, the autoclave was sealed and heated at 200° C. for 2 hours. Subsequently, the inside of the system was evacuated while being heated and de-ammoniation was performed, thereby obtaining the fine particle substrate 1.

### Manufacturing of Fine Particle Substrates 2 to 4

Similarly to the fine particle substrate 1, the heating temperatures, the stirring speeds, and the dropwise addition time were adjusted to achieve the values in Table 1 as the particle diameters of obtained silica fine particles, thereby obtaining fine particle substrates 2 to 4 (sol-gel silica).

### Manufacturing of Fine Particle Substrate 5

With respect to 100 parts of silica fine particle 2 obtained by the above-described silica fine particle manufacturing example, 945 parts by mass of methanol, 45 parts by mass of 28% ammonia water, and 135 parts by mass of water were added and mixed. The temperature of the solution was adjusted to 35° C., and 405 parts by mass of tetramethoxysilane was added dropwise for 6 hours while the solution was stirred, stirring was further continued for 1 hour after the dropwise addition to perform hydrolysis, thereby preparing a dispersion of the silica particle. In a state where the dispersion was warmed to and retained at 70° C., 5 mol/L of aqueous solution of sodium hydroxide was added dropwise such that pH became 8.0, an amount of sodium aluminate as alumina corresponding to 30% by mass with respect to the mass of silica was added thereto, thereby preparing a slurry containing an alumina-covered silica particle. Thereafter, pH of the slurry was neutralized to 5.0, the solution was retained and aged for 30 minutes while being stirred at a temperature of 80° C. The slurry was vacuum-distilled and dried, and the fine particle was then crushed, thereby preparing a fine particle substrate 5 (silica alumina). The number-average primary particle diameter (D50) of the fine particle substrate 5 obtained by the above-described method was measured to be 20 nm.

### Fine Particle Substrate 6

As a fine particle substrate 6, fumed silica (REOLOSIL QS-30 manufactured by Tokuyama Corporation) with a specific surface area of 300 m²/g was used. The number-average primary particle diameter (D50) was measured to be 7 nm.

### Manufacturing of Fine Particle Substrate 7

Hydrated titanium oxide obtained by hydrolyzing an aqueous solution of titanyl sulfate was washed with pure water until electrical conductivity of the filtrate became 2200 μS/cm. NaOH was added to the hydrated titanium oxide slurry, and an adsorbed sulfate radical was washed until SO₃ became 0.24%. Next, hydrochloric acid was added to the hydrated titanium oxide slurry to adjust pH of the slurry to 1.0, thereby obtaining a titania sol dispersion. NaOH was added to the titania sol dispersion to adjust pH of the dispersion to 6.0, and washing was performed by decantation using pure water until the electric conductivity of the supernant became 120 μS/cm.

To a SUS reaction vessel, 533 g (0.6 mole) of metatitanic acid with a water content of 91% obtained as described above was put, nitrogen gas was blown thereto, and the reaction container was left for 20 minutes to replace the inside thereof with nitrogen gas. 183.6 g (0.66 mole) of Sr(OH)₂·8H₂O (purity of 95.5%) was added thereto, and distilled water was further added thereto, thereby preparing a slurry of 0.3 mole/litter (in terms of SrTiO₃) and an SrO/TiO₂ molar ratio of 1.10.

The slurry was heated to 90° C. in a nitrogen atmosphere, and the reaction was performed. The slurry was cooled to 40° C. after the reaction, was placed in the nitrogen atmosphere, the supernant was removed, washing was performed by repeating an operation of performing decantation by adding 2.5 L of pure water twice, and filtration was then performed with a Nutsche filter. The obtained cake was dried for 4 hours in an atmospheric air at 110° C., thereby obtaining a fine particle substrate 7 (strontium titanate). The number-average primary particle diameter (D50) of the fine particle substrate 5 obtained by the above-described method was measured to be 40 nm.

TABLE 1

| | | Number-average |
|---|---|---|
| | | particle diameter |
| | Base material | of primary particle |
| Fine particle substrate 1 | Sol-gel silica | 12 nm |
| Fine particle substrate 2 | Sol-gel silica | 18 nm |
| Fine particle substrate 3 | Sol-gel silica | 47 nm |
| Fine particle substrate 4 | Sol-gel silica | 28 nm |
| Fine particle substrate 5 | Silica alumina | 20 nm |
| Fine particle substrate 6 | Fumed silica | 7 nm |
| Fine particle substrate 7 | Strontium titanate | 40 nm |

### Manufacturing of Fine Particle 1

100 g of fine particle substrate 1 obtained by the above-described manufacturing was weighed, was dispersed in 2 L of water, and was then warmed to 80° C. An aqueous solution of aluminum chloride was added in an amount corresponding to 10% by mass in terms of Al₂O₃ with respect to the fine particle substrate 1, pH was adjusted to 5.5 with an aqueous solution of sodium hydroxide, and the solution was then retained while being stirred for 1 hour, thereby covering the surface of the fine particle substrate 1 with aluminum hydroxide.

Next, isobutyltrimethoxysilane was added in an amount corresponding to 10% by mass with respect to the fine particle substrate 1, pH was added to 7.0 with an aqueous solution of sodium hydroxide, and the solution was retained while being stirred for 1 hour, thereby obtaining a slurry of the fine particle 1 covered with a silane coupling agent. The resulting slurry was filtered and the residue on the filter medium was washed with water to give a washed cake. The washed cake was dried at 120° C. and was pulverized with a media-type pulverizer, thereby producing the fine particle 1. Obtained physical properties are shown in Table 2.

### Manufacturing of Fine Particles 2 and 5

Fine particles 2 and 5 were obtained similarly to the manufacturing of the fine particle 1 other than that the fine particle substrate 1 was changed to the fine particle substrate 2 and the fine particle substrate 5, respectively. Physical properties are shown in Table 2.

### Manufacturing of Fine Particle 8

A fine particle 8 was obtained similarly to the manufacturing of the fine particle 1 other than that the fine particle substrate 1 was changed to the fine particle substrate 2 and isobutyltrimethoxysilane was changed to octyltriethoxysilane. Physical properties are shown in Table 2.

### Manufacturing of Fine Particle 3

100 g of fine particle substrate 3 obtained by the above-described manufacturing was weighed, was dispersed in 2 L of water, and was then warmed to 80° C. An aqueous solution of aluminum chloride corresponding to 10% by mass in terms of Al₂O₃ with respect to the fine particle substrate 3 was added, pH was added to 5.5 with an aqueous solution of sodium hydroxide, and the solution was retained while being stirred for 1 hour, thereby obtaining a slurry of the fine particle 3 in which the surface of the fine particle substrate 3 was covered with aluminum hydroxide. The resulting slurry was filtered and the residue on the filter medium was washed with water to give a washed cake. The washed cake was dried at 120° C. and was pulverized with a media-type pulverizer, thereby producing the fine particle 3. Obtained physical properties are shown in Table 2.

### Manufacturing of Fine Particles 4, 6, and 7

A fine particle 4, a fine particle 6, and a fine particle 7 were obtained similarly to the manufacturing of the fine particle 3 other than that the fine particle substrate 3 was changed to the fine particle substrate 4, the fine particle substrate 6, and the fine particle substrate 7, respectively. Physical properties are shown in Table 2.

### Manufacturing of Fine Particle 9

A fine particle 9 was obtained similarly to the manufacturing of the fine particle 3 other than that the fine particle substrate 3 was changed to the fine particle substrate 5. Physical properties are shown in Table 2.

TABLE 2

| | Fine | | | Number- | |
|---|---|---|---|---|---|
| | parti- | | | average | |
| | cle | | | particle | Aluminum |
| | sub- | | Surface | diameter of | hydroxide |
| | strate | | treatment | primary | coverage |
| | No. | Coating | agent | particle | ratio |
| Fine | 1 | Aluminum | Isobutyltrime- | 15 nm | 80% |
| particle 1 | | hydroxide | thoxysilane | | |
| Fine | 2 | Aluminum | Isobutyltrime- | 20 nm | 80% |
| particle 2 | | hydroxide | thoxysilane | | |
| Fine | 3 | Aluminum | None | 50 nm | 70% |
| particle 3 | | hydroxide | | | |
| Fine | 4 | Aluminum | None | 30 nm | 70% |
| particle 4 | | hydroxide | | | |
| Fine | 5 | Aluminum | Isobutyltrime- | 23 nm | 80% |
| particle 5 | | hydroxide | thoxysilane | | |
| Fine | 6 | Aluminum | None | 10 nm | 110% |
| particle 6 | | hydroxide | | | |
| Fine | 7 | Aluminum | None | 42 nm | 90% |
| particle 7 | | hydroxide | | | |
| Fine | 2 | Aluminum | Octyltriethoxy- | 20 nm | 80% |
| particle 8 | | hydroxide | silane | | |
| Fine | 5 | Aluminum | None | 23 nm | 70% |
| particle 9 | | hydroxide | | | |

### Manufacturing of Titanium Oxide Fine Particle 1

An ilmenite ore containing 50% by mass of the portion corresponding to TiO₂ was dried at 150° C. for 3 hours, and sulfuric acid was then added thereto to dissolve the ilmenite ore, thereby obtaining an aqueous solution of TiOSO₄. The obtained aqueous solution was concentrated, and 10 parts of titania sol having a rutile crystal was then added as a seed, hydrolysis was then performed at 170° C., thereby obtaining a slurry of TiO(OH)₂ containing impurities. The slurry was repeatedly washed at pH 5 to 6 to sufficiently remove the sulfuric acid, FeSO₄, and the impurities, thereby obtaining a slurry of metatitanic acid [TiO(OH)₂] with high purity.

The slurry was filtered, 0.5 parts of lithium carbonate (Li₂CO₃) was added thereto, the resultant product was fired at 250° C. for 3 hours, and crushing treatment was then repeated by jet mill, thereby obtaining titanium oxide fine particle having a rutile crystal. The obtained titanium oxide fine particle was dispersed in ethanol and stirred, and 5 parts of isobutyltrimethoxysilane was added dropwise as a surface treatment agent with respect to 100 parts of titanium oxide fine particle, the resultant product was mixed and reacted. After the resultant product was dried, was heated at 170° C. for 3 hours, and was repeatedly subjected to crushing treatment by jet mil until there became no aggregates of titanium oxide, thereby obtaining a titanium oxide fine particle 1.

The powder specific resistivity RB of the obtained titanium oxide fine particle 1 was 1.3×10⁵ Ωm. The shape was a needle-like shape, the number-average particle diameter of the major axis of the primary particle was 25 nm, and the number-average particle diameter of the minor axis was 5 nm.

### Manufacturing of Titanium Oxide Fine Particle 2

A titanium oxide fine particle 2 having an anatase crystal was obtained similarly to the manufacturing of the titanium oxide fine particle 1 other than that the titania sol used as a seed was changed from the rutile crystal to the anatase crystal.

The powder specific resistivity RB of the obtained titanium oxide fine particle was 1.8×10⁵ Ωm. The shape was a granular shape, and the number-average particle diameter of the primary particle was 20 nm.

### Manufacturing of Toner Particle 1

Resin particle dispersion of polyester A-1: 900 parts
Resin particle dispersion of crystalline polyester B-1: 100 parts
Coloring agent particle 1 dispersion: 50 parts
Release agent particle dispersion: 80 parts

First, each of the materials was put in a round stainless flask and mixed. Subsequently, the mixture was dispersed at 5,000 r/min for 10 minutes using a homogenizer Ultra-Turrax T50 (manufactured by IKA). 1.0% aqueous solution of nitric acid was added, pH was adjusted to 3.0, and 30 parts of 2.0% by mass aqueous solution of aluminum sulfate was then added over 30 minutes. The mixed liquid was heated to 58° C. using a stirring blade in a water bath for heating while the number of revolutions was appropriately adjusted such that the mixture solution was stirred.

The volume-average particle diameter of the formed aggregated particle was appropriately checked using Coulter Multisizer III, and the aggregation process was ended when the aggregate particle of 6.0 μm was formed.

Thereafter, a 5% aqueous solution of sodium hydroxide was used to adjust pH to 9.0, and the temperature was heated to 92° C. while the stirring was continued, as a spheroidization process.

The heating was stopped when a desired surface shape was obtained, ice was quickly input such that the cooling speed became equal to or greater than 10° C./second to cool the temperature to 40° C. as a cooling process, and an annealing treatment was performed at 55° C. for 3 hours as an annealing process.

After that, the mixture was cooled to 25° C., filtration and solid-liquid separation was performed, and washing was then performed with ion exchanged water. After the washing, the mixture was dried using a vacuum drier, thereby obtaining a toner particle 1 with a weight-average particle diameter (D4) of 7.1 μm. The physical properties of the toner particle 1 are shown in Table 3.

### Manufacturing of Toner Particle 2

A toner particle 2 was obtained similarly to the manufacturing of the toner particle 1 other than that 30 parts of 2.0% by mass aqueous solution of aluminum sulfate was changed to 10 parts of 2.0% by mass aqueous solution of aluminum sulfate and the coloring agent particle 1 dispersion was changed to the coloring agent particle 2 dispersion. Physical properties are shown in Table 3.

### Manufacturing of Toner Particle 3

A toner particle 3 was obtained similarly to the manufacturing of the toner particle 1 other than that 30 parts of 2.0% by mass aqueous solution of aluminum sulfate was changed to 50 parts of 4.0% by mass aqueous solution of aluminum sulfate, the coloring agent particle 1 dispersion was changed to the coloring agent particle 2 dispersion, and the resin particle dispersion of the crystalline polyester B-1 was changed to the resin particle dispersion of the crystalline polyester B-2. Physical properties are shown in Table 3.

### Manufacturing of Toner Particle 4

A toner particle 4 was obtained similarly to the manufacturing of the toner particle 1 other than that 30 parts of 2.0% by mass aqueous solution of aluminum sulfate was changed to 50 parts of 2.0% by mass aqueous solution of aluminum sulfate, the coloring agent particle 1 dispersion was changed to the coloring agent particle 2 dispersion, and the resin particle dispersion of the polyester A-1 was changed to the resin particle dispersion of the polyester A-2. Physical properties are shown in Table 3.

### Manufacturing of Toner Particle 5

A toner particle 5 was obtained similarly to the manufacturing of the toner particle 1 other than that 30 parts of 2.0% by mass aqueous solution of aluminum sulfate was changed to 30 parts of 3.0% by mass aqueous solution of magnesium chloride. Physical properties are shown in Table 3.

TABLE 3

| | | | Coloring | | Weight- |
|---|---|---|---|---|---|
| Toner | | Crystal- | agent | | average |
| particle | Poly- | line | particle | Aggregating | particle |
| No. | ester | polyester | dispersion | agent | diameter |
| 1 | A-1 | B-1 | 1 | Aluminum sulfate | 7.1 μm |
| 2 | A-1 | B-1 | 2 | Aluminum sulfate | 7.3 μm |
| 3 | A-1 | B-2 | 2 | Aluminum sulfate | 6.9 μm |
| 4 | A-2 | B-1 | 2 | Aluminum sulfate | 7.5 μm |
| 5 | A-1 | B-1 | 1 | Magnesium chloride | 7.2 μm |

### Manufacturing of Toner Particle 6

Toner particle 1: 100 part
Ionic surfactant Neogen RK (manufactured by Daiichi Kogyo Co., Ltd.): 5 part
Ion exchanged water: 500 part
Titanium oxide fine particle 1: 1 part

The above materials were stirred for 30 minutes at the number of revolutions of 50 (1/s) using “Clairemix” (manufactured by M Technique Co., Ltd.), thereby uniformly dispersing the toner base particle and the titanium oxide fine particle.

### Wet Process (1)

Next, the temperature of the dispersion was raised to 60° C., and stirring was performed for 60 minutes with the number of revolutions set to 70 (1/s) using the aforementioned Clairemix in the state where the temperature was maintained at 60° C., thereby fixing the titanium oxide fine particle to the toner particle surface.

### Wet Process (2)

Next, the temperature of the stirring tank was raised to 80° C. and was maintained for 60 hours with the number of revolutions of the aforementioned Clairemix set to 30 (1/s), thereby obtaining a toner dispersion. The obtained toner dispersion was subjected to solid-liquid separation by a pressure filter, thereby obtaining a toner cake. This was subjected to reslurry with ion exchanged water and formed into a dispersion again, and the dispersion was then subjected to solid-liquid separation using the pressure filter. After reslurry and solid-liquid separation were repeated until the electrical conductivity of the filtrate became 5.0 μS/cm or less, solid-liquid separation was finally performed to obtain a toner cake. The obtained toner cake was dried and was further classified using a classifier, thereby obtaining a toner particle 6.

### Manufacturing of Toner 1

External addition was performed on the above-described toner particle 6. The following materials were input to an FM mixer (FM10C model manufactured by Nippon Coke & Engineering. Co., Ltd.) through which water at 7° C. was caused to pass inside a jacket. After the water temperature inside the jacket was stabilized at 7° C.±1° C., mixing was performed at a circumferential speed of 20 m/sec of the rotation blade for 5 minutes, thereby obtaining a toner mixture. The amount of water caused to pass inside the jacket was appropriately adjusted such that the temperature inside the tank of the FM mixer did not exceed 25° C. at this time. The toner was sieved with a mesh having an opening of 75 μm to obtain a toner 1. The configuration of the toner 1 is also shown in Table 4.
Toner particle 6: 100 parts by mass
Fine particle 5: 0.50 parts by mass
Fumed silica (REOLOSIL QS-30 manufactured by Tokuyama Corporation) 1.00 parts by mass

### Manufacturing of Toner 2

External addition was performed on the above-described toner particle 1. The following materials were input to an FM mixer (FM10C model manufactured by Nippon Coke & Engineering. Co., Ltd.) through which water at 53° C. was caused to pass inside a jacket. After the water temperature inside the jacket was stabilized at 53° C.±1° C., mixing was performed at a circumferential speed of 35 m/sec of the rotation blade for 5 minutes, thereby obtaining a toner mixture intermediate product. The amount of water caused to pass inside the jacket was appropriately adjusted such that the temperature inside the tank of the FM mixer was stabilized at 53° C.±1° C. at this time.
Toner particle 1: 100 parts by mass
Titanium oxide fine particle 1: 0.50 parts by mass

External addition was further performed on the above-described toner mixture intermediate product. The following materials were input to an FM mixer (FM10C model manufactured by Nippon Coke & Engineering. Co., Ltd.) through which water at 7° C. was caused to pass inside the jacket. After the water temperature inside the jacket was stabilized at 7° C.±1° C., mixing was performed at a circumferential speed of 20 m/sec of the rotation blade for 5 minutes, thereby obtaining a toner mixture. The amount of water caused to pass inside the jacket was appropriately adjusted such that the temperature inside the tank of the FM mixer did not exceed 25° C. at this time. The toner was sieved with a mesh having an opening of 75 μm to obtain a toner 2. The configuration of the toner 2 is also shown in Table 4.
Toner intermediate mixture: 100 parts by mass
Fine particle 1: 0.50 parts by mass
Fumed silica (REOLOSIL QS-30 manufactured by Tokuyama Corporation): 1.00 parts by mass

### Manufacturing of Toner 3

A toner 3 was obtained similarly to the manufacturing of the toner 2 other than that the toner particle 1 was changed to the toner particle 2 and the fine particle 1 was changed to the fine particle 2. The configuration is also shown in Table 4.

### Manufacturing of Toner 4

A toner 4 was obtained similarly to the manufacturing of the toner 2 other than that the toner particle 1 was changed to the toner particle 2 and the fine particle 1 was changed to the fine particle 8. The configuration is also shown in Table 4.

### Manufacturing of Toner 5

A toner 5 was obtained similarly to the manufacturing of the toner 2 other than that the toner particle 1 was changed to the toner particle 2 and the fine particle 1 was changed to the fine particle 3. The configuration is also shown in Table 4.

### Manufacturing of Toner 6

A toner 6 was obtained similarly to the manufacturing of the toner 2 other than that the toner particle 1 was changed to the toner particle 3, the titanium oxide fine particle 1 was changed to the titanium oxide fine particle 2, and the fine particle 1 was changed to the fine particle 3. The configuration is also shown in Table 4.

### Manufacturing of Toner 7

A toner 7 was obtained similarly to the manufacturing of the toner 1 other than that the toner particle 6 was changed to the toner particle 2 and the fine particle 5 was changed to the fine particle 4. The configuration is also shown in Table 4.

### Manufacturing of Toner 8

A toner 8 was obtained similarly to the manufacturing of the toner 1 other than that the toner particle 6 was changed to the toner particle 4 and the fine particle 5 was changed to the fine particle 6. The configuration is also shown in Table 4.

### Manufacturing of Toner 9

A toner 9 was obtained similarly to the manufacturing of the toner 1 other than that the toner particle 6 was changed to the toner particle 2 and the fine particle 5 was changed to the fine particle 7. The configuration is also shown in Table 4.

### Manufacturing of Comparative Toner 1

A comparative toner 1 was obtained similarly to the manufacturing of the toner 1 other than that the toner particle 6 was changed to the toner particle 5 and the fine particle 5 was changed to the fine particle 9. The configuration is also shown in Table 4.

### Manufacturing of Comparative Toner 2

A comparative toner 2 was obtained similarly to the manufacturing of the toner 1 other than that the toner particle 6 was changed to the toner particle 2 and the fine particle 5 was changed to the fine particle substrate 4. The configuration is also shown in Table 4.

Physical properties of each obtained toner were measured by the aforementioned ways. In the toners 1 to 6, it was possible to confirm regions where the inorganic fine particles were embedded on the toner particle surfaces. Numerical values of C_{Al} are shown in Table 4.

The coverage ratio of aluminum with respect to the substrate in the fine particle included in each toner was measured by the aforementioned procedure, and the same value as that in Table 2 was obtained.

TABLE 4

| | Toner | Titanium | Fine | Fine particle | |
|---|---|---|---|---|---|
| | particle | oxide fine | particle | substrate | C_{Al} |
| | No. | particle No. | No. | No. | atomic % |
| Toner 1 | 6 | — | 5 | — | 0.001 |
| Toner 2 | 1 | 1 | 1 | — | 0.3 |
| Toner 3 | 2 | 1 | 2 | — | 0.1 |
| Toner 4 | 2 | 1 | 8 | — | 0.1 |
| Toner 5 | 2 | 1 | 3 | — | 0.1 |
| Toner 6 | 3 | 2 | 3 | — | 2.0 |
| Toner 7 | 2 | — | 4 | — | 0.1 |
| Toner 8 | 4 | — | 6 | — | 0.5 |
| Toner 9 | 2 | — | 7 | — | 0.1 |
| Comparative | 5 | — | 9 | — | Not |
| toner 1 | | | | | detected |
| Comparative | 2 | — | — | 4 | 0.1 |
| toner 2 | | | | | |

### Evaluation

A color laser printer, HP LaserJet Enterprise Color M555dn with a mono-component toner contact development blade cleaning system mounted thereon and a consumable cartridge therefor, namely a cartridge CRG for the HP212X yellow toner were modified and used.

The main body was modified such that the process speed became 150% and printing tests were able to be performed only at a yellow station. Evaluation was conducted by setting the toner filling amount of the cartridge to 50 g. Replenishment of 30 g was performed when the remaining amount of toner became 20 g when images were continuously output. In this manner, a small amount of toner was continuously used in a high-speed process, and a stress that the toner received increased.

For printing, A4 paper (product name: “GF-C081”, 81.4 g/m², manufactured by Canon Inc.) was used.

### Evaluation 1. Measurement of Solid Density Difference in Low-Temperature and Low-Humidity Environment and High-Temperature and High-Humidity Environment

The evaluation was performed in a low-temperature and low-humidity environment (15° C./10% RH) and a high-temperature and high-humidity environment (32° C./85% RH).

The printer was left in the low-temperature and low-humidity environment for 24 hours, 10 sheets of 50% half-tone images were then printed, and one sheet of a full-screen solid image was then printed. Next, the printer was left in the high-temperature and high-humidity environment for 24 hours, 10 sheets of 50% half-tone images were then printed, and one sheet of a full-screen solid image was then printed.

The density was measured at the center of each solid image in the printing direction using a portable spectrophotometer exact advance (manufactured by X-Rite, Incorporated), and evaluation was conducted from the density difference in accordance with the following criteria. The evaluation results are presented in Table 5.

### Evaluation Criteria

A: Less than 0.10
B: 0.10 or more and less than 0.20
C: 0.20 or more and less than 0.30
D: 0.30 or more

### Evaluation 2. Measurement of Initial Standing Fogging in High-Temperature and High-Humidity Environment

Fogging is particularly pronounced in image output immediately after the printer is stopped and is then restarted on the next day, and this so-called “standing fogging” is caused by insufficient rising of the amount of charge of the toner.

After the measurement of the evaluation 1, 100 sheets of full-screen white color image were output, and the power source of the printer was then turned off in the same high-temperature and high-humidity environment and was left for 72 hours. Thereafter, 5 sheets of full-screen white color image was similarly output. A fogging density (%) was calculated from a difference of a whiteness level at white base parts of the output images measured by “REFLECTMETER MODEL TC-6DS” (manufactured by Tokyo Denshoku Co., Ltd.) and a whiteness level of the evaluation sheets, and initial standing fogging was evaluated in accordance with the following criteria. As a filter, an amber filter was used. As the fogging density, measurement was conducted at three points, namely a left upper point, a center point, and a right lower point, for each of five images, and an average value of the values at a total of 15 points was obtained. The evaluation results are presented in Table 5.

### Evaluation Criteria

A: Less than 1.00%
B: 1.00% or more and less than 1.50%
C: 1.50% or more and less than 2.00%
D: 2.00% or more and less than 2.50%
E: 2.50% or more
   Evaluation 3. Measurement of Standing Fogging after Period of Durability in High-Temperature and High-Humidity Environment

Following the measurement of the evaluation 2, a durability test was performed in which 30000 sheets were output with an image with a printing rate of 1.0% at an intermittent time of 2 seconds for every two sheets in a high-temperature and high-humidity environment. After the image output of 30000 sheets, the power source of the printer was turned off in the same environment, and the printer was left for 72 hours. Thereafter, 5 sheets of full-screen white color image were similarly output. The fogging density (%) was calculated similarly to the initial standing fogging, and the durability period standing fogging was evaluated in accordance with the following criteria. The evaluation results are presented in Table 5.

### Evaluation Criteria

A: Less than 1.00%
B: 1.00% or more and less than 1.50%
C: 1.50% or more and less than 2.00%
D: 2.00% or more and less than 2.50%
E: 2.50% or more
   Evaluation 4. Evaluation of Image Streaks after Period of Durability in High-Temperature and High-Humidity Environment

Image streaks are vertical image streaks caused by a toner with a large amount of charge being attached to the charged member due to a high electrostatic adhesion force and contaminating the charged member due to rubbing, and are image defects that are often observed when full-screen half-tone images are output.

Following the measurement of the evaluation 3, 50% half-tone images were output on full screens in a high-temperature and high-humidity environment, and presence/absence of streaks was observed. Evaluation ranks in regard to the image streaks were applied to the obtained images in accordance with the following criteria. The evaluation results are presented in Table 5.

### Evaluation Criteria of Image Streaks

A: No streaks were generated
B: One to two streaks were generated
C: Three to four streaks were generated
D: Five to six streaks were generated
E: Seven or more streaks were generated
   Evaluation 5. Evaluation of Density Uniformity of Solid Image after Period of Durability in High-Temperature and High-Humidity Environment

For the purpose of confirming fluidity of the toner, image density non-uniformity of the full-screen solid image after the period of durability was evaluated.

Following the evaluation 4, 5 sheets of full-screen solid image were continuously printed in the same high-temperature and high-humidity environment. Densities were measured in the first and fifth images among these using a portable spectrophotometer exact advance (manufactured by X-Rite, Incorporated). The measurement locations were the left end, the center, and the right end of the leading end of the first sheet in the printing direction and the left end, the center, and the right end of the trailing end of the fifth sheet in the printing direction. Density non-uniformity of the solid images were determined from the density difference between the maximum value and the minimum value of the image densities at the total of six points in accordance with the following criteria. The evaluation results are presented in Table 5.

### Evaluation Criteria for Density Homogeneity

A: The density difference of the solid images was less than 0.05
B: The density difference of the solid images was 0.05 or more and less than 0.10
C: The density difference of the solid images was 0.10 or more and less than 0.15
D: The density difference of the solid images was 0.15 or more and less than 0.20
E: The density difference of the solid images was 0.20 or more

TABLE 5

| | | | | | | | | | Evaluation 4. | | | |
|---|---|---|---|---|---|---|---|---|---|---|---|---|
| | | | | | | | Evaluation 3. | | Image streaks after | | Evaluation 5. | |
| | | | | | Evaluation 2. | | Standing fogging | | period of durability | | Density uniformity of | |
| | Evaluation 1. Solid density | | | | Initial standing | | after period of | | Number | | solid image after | |
| Toner | difference | | | | fogging | | durability | | of | | period of durability | |
| No. | DHH | DLL | DD | Rank | Fogging | Rank | Fogging | Rank | streak(s) | Rank | DD | Rank |
| 1 | 1.42 | 1.46 | 0.04 | A | 0.10% | A | 0.20% | A | 0 | A | 0.03 | A |
| 2 | 1.38 | 1.45 | 0.07 | A | 0.20% | A | 0.50% | A | 0 | A | 0.04 | A |
| 3 | 1.37 | 1.45 | 0.08 | A | 0.40% | A | 0.60% | A | 2 | B | 0.03 | A |
| 4 | 1.33 | 1.45 | 0.12 | B | 0.40% | A | 0.60% | A | 2 | B | 0.02 | A |
| 5 | 1.24 | 1.45 | 0.21 | C | 0.50% | A | 0.80% | A | 1 | B | 0.04 | A |
| 6 | 1.19 | 1.45 | 0.26 | C | 0.70% | A | 0.90% | A | 3 | C | 0.07 | B |
| 7 | 1.22 | 1.45 | 0.23 | C | 0.80% | A | 1.20% | B | 4 | C | 0.12 | C |
| 8 | 1.17 | 1.45 | 0.28 | C | 1.20% | B | 1.40% | B | 2 | B | 0.13 | C |
| 9 | 1.20 | 1.45 | 0.25 | C | 1.40% | B | 1.90% | C | 4 | C | 0.14 | C |
| C. 1 | 1.16 | 1.45 | 0.29 | C | 2.20% | D | 2.50% | E | 8 | E | 0.19 | D |
| C. 2 | 1.11 | 1.45 | 0.34 | D | 2.70% | E | 2.90% | E | 10 | E | 0.18 | D |

In the Table 5, “C.” indicates “Comparative”, DHH indicates “Density at high temperature and high humidity”, DLL indicates “Density at low temperature and low humidity”, and DD indicates “Density difference”.

According to the present disclosure, it is possible to provide a toner that can achieve both an improvement in charge buildup capability and an increase in lifetime achieved by reducing member contamination.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-189017, filed Oct. 28, 2024, which is hereby incorporated by reference herein in its entirety.

What is claimed is:

1. A toner comprising:
a toner particle; and
a fine particle that is present on a surface of the toner particle,
wherein the toner particle comprises an aluminum element on the surface of the toner particle, and
the fine particle comprises aluminum hydroxide on a surface the fine particle.

2. The toner according to claim 1,
wherein the fine particle comprises a substrate and the aluminum hydroxide on a surface of the substrate, and
the substrate is an inorganic oxide fine particle.

3. The toner according to claim 2, wherein the substrate comprises a silica fine particle.

4. The toner according to claim 2, wherein a coverage ratio of an aluminum element included in the aluminum hydroxide with respect to the substrate, which is calculated from a mapping image of the aluminum hydroxide and an element of the substrate obtained through element mapping analysis using STEM on the fine particle, is 40 to 110%.

5. The toner according to claim 1, wherein the amount C_{Al} of the aluminum element present on the surface of the toner particle obtained by TOF-SIMS is 0.001 atomic % to 2.0 atomic %.

6. The toner according to claim 1, wherein the toner has a region in which an inorganic fine particle is embedded on the surface of the toner particle.

7. The toner according to claim 6, wherein the inorganic fine particle is a needle-like titanium oxide fine particle.

8. The toner according to claim 1, wherein the fine particle is surface-treated with an alkyltrialkoxysilane.

9. The toner according to claim 8, wherein the alkyltrialkoxysilane is isobutyltrimethoxysilane.

10. The toner according to claim 1, wherein the toner particle comprises C.I. Pigment yellow 74.
